(19) United States
(12) Patent Application Publication
(10) Pub. No.: US 2024/0352315 A1
(43) Pub. Date: Oct. 24, 2024

(54) METHODS AND COMPOSITIONS FOR ENHANCED DISPERSION OF PHOSPHOR IN A POLYMERIC MATRIX

(71) Applicant: Board of Regents, The University of Texas System, Austin, TX (US)

(72) Inventors: Wei Chen, Arlington, TX (US); Omar Darrel Johnson, Fort Worth, TX (US); Sunil Sahi, Arlington, TX (US)

(21) Appl. No.: 18/754,451

(22) Filed: Jun. 26, 2024

Related U.S. Application Data
(62) Division of application No. 17/265,443, filed on Feb. 2, 2021.
(60) Provisional application No. 62/714,543, filed on Aug. 3, 2018.

(51) Int. Cl. C09K 11/77; A01G 9/14; C09K 11/02

(52) U.S. Cl. CPC C09K 11/7731; C09K 11/02; A01G 9/1438

(57) ABSTRACT

In one aspect, the disclosure relates to compositions comprising a surface-modified phosphor material comprising a phosphor material and a silane, methods of making same, and articles comprising same. This abstract is intended as a scanning tool for purposes of searching in the particular art and is not intended to be limiting of the present disclosure.

### CROSS-REFERENCE TO RELATED APPLICATIONS

This application is a divisional application of U.S. nonprovisional application Ser. No. 17/265,443 filed on Feb. 2, 2021, which is a US national phase application of international application no. PCT/US2019/045022 filed on Aug. 3, 2019, which claims priority upon U.S. provisional application Ser. No. 62/714,543 filed on Aug. 3, 2018. These applications are hereby incorporated by reference in their entirety.

### TECHNICAL FIELD

The present disclosure relates to compositions and methods for surface treatment of luminescent phosphors, e.g., sulfide phosphors, which provide enhanced dispersion of such luminescent phosphors in a matrix, e.g., a polymeric matrix.

### BACKGROUND

The normal electromagnetic spectrum of sunlight, i.e., solar radiation, comprises electromagnetic radiation having wavelengths from UV through visible to IR. Photosynthetic organisms, such as plants, use a spectral range (wave band) of solar radiation from 400 to 700 nanometers, which is designated as Photosynthetic Active Radiation (PAR). For photosynthesis, plants absorb only blue and red light from solar radiation.

A limitation of traditional greenhouse canopies is that they do not have the capability to convert specific solar wavelengths to desired wavelengths for efficient photosynthesis.

Luminescent phosphors can be used to convert a first wavelength of light from a source into a second, more desirable wavelength of light. Although, in principal, it would be desirable fabricate greenhouse canopies to convert various solar radiation into desired blue and red light using luminescent phosphors, conventionally available methods for using luminescent phosphors in a a matrix, such as a polymeric matrix, result in aggregation of the luminescent phosphors. Such aggregation of luminescent phosphors in a polymeric matrix typically results in a loss of light transmission through the matrix. Moreover, aggregation affects the light converting properties of these phosphors.

Conventionally available methods developed to improve the dispersion of inorganic particles in polymeric matrices include in situ methods in which functionalized inorganic particles are synthesized in the polymer matrix during the polymerization process. However, this method results in very low particle concentrations. Furthermore, this method is mostly limited to oxides and metal particles, e.g., U.S. Patent Publ. No. 2003/0148042A1 discloses the use of ultrasonic energy along with coupling agents in an attempt to improve the dispersion of inorganic particles into polymer matrix. Nevertheless, it is difficult to get a uniform dispersion of particles using this technique. Ligand exchange methods have also been utilized to disperse semiconductor particles in the polymer in which functionalized particles are synthesized in an aqueous solution and transferred into organic solvents using ligands that allow ease of dispersion in the polymer matrix. However, this process is mainly limited to cadmium based semiconductor particles and the transfer yield can be low.

Despite advances in research directed to useful dispersion of luminescent phosphors in polymeric matrices, there a scarcity of efficacious methods and compositions that permit the uniform dispersion of a broad range of luminescent phosphors at high particle concentrations with maintenance of the desired light converting properties of the luminescent phosphor. These needs and other needs are satisfied by the present disclosure.

### SUMMARY

In accordance with the purpose(s) of the present disclosure, as embodied and broadly described herein, the disclosure, in one aspect, relates to compositions comprising a surface-modified phosphor material comprising a phosphor material and a silane coupling agent, methods of making same, and articles comprising same.

In various aspects, the present disclosure pertains to methods of preparing a surface-modified phosphor material, the method comprising: preparing a phosphor material mixture comprising a phosphor material and a liquid comprising a first alcohol; preparing a surface-modifying solution comprising a silane coupling agent, water, and a second alcohol; preparing a surface-modifying phosphor reaction mixture by mixing the phosphor material mixture and the surface-modifying solution; and heating the surface-modifying phosphor reaction mixture in an inert atmosphere; thereby forming the surface-modified phosphor material.

In a further aspect, the present disclosure pertains to surface-modified phosphor compositions prepared by the disclosed methods.

In a further aspect, the present disclosure pertains to articles comprising the disclosed surface-modified phosphor compositions.

In a further aspect, the present disclosure pertains to greenhouse glazing comprising the disclosed articles.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure.

Moreover, in the drawings, like reference numerals designate corresponding parts throughout the several views.

FIG. 1 shows representative photoluminescence emission and excitation data for a disclosed surface-modified phosphor before and after coating prepared using methods and compositions disclosed herein.

FIG. 2 shows representative photoluminescence emission and excitation data for a disclosed article comprising a disclosed surface-modified phosphor prepared using methods and compositions disclosed herein.

FIGS. 3A-3B show representative photographic images of a disclosed phosphor dispersed in a disclosed resin in which the phosphor is uncoated (see FIG. 3A) or a disclosed surface-modified phosphor prepared using methods and compositions disclosed herein (see FIG. 3B).

FIGS. 4A-4B show representative photographic images of a representative disclosed article comprising a disclosed surface-modified phosphor dispersed in a disclosed resin under ambient room light (see FIG. 4A) or under exposure to UV irradiation (see FIG. 4B).

FIG. 5 shows representative FTIR spectra data obtained for disclosed surface-modified phosphor powders prepared with different silane material coatings as indicated (3-(mercaptopropyl)trimethoxy silane or and 3-(trimethoxysilyl)propyl methacrylate).

FIG. 6 shows representative photoluminescence data obtained for a disclosed polymer film comprising disclosed surface-modified phosphor powders dispersed therein. The polymer used for the film was polymethyl methacarylate, and the disclosed surface-modified phosphor powder comprised a coating prepared using 3-(trimethoxysilyl)propyl methacrylate. The weight percent loadings of the disclosed surface-modified phosphor in the polymer film were as indicated in the figure. The film thickness was 2 mm; and excitation for the photoluminescence was 470 nm.

FIG. 7 shows representative photoluminescence data obtained for disclosed surface-modified phosphor powders. Photoluminescence data are shown, as indicated, for a control uncoated phosphor; a coated phosphor coated using a low concentration (0.005 v/v) of 3-(trimethoxysilyl)propyl methacrylate; and a coated phosphor coated using a high concentration (0.05 v/v) of 3-(trimethoxysilyl)propyl methacrylate. Excitation for the photoluminescence was 470 nm.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a silane,” “a phosphor material,” or “a matrix material,” including, but not limited to, two or more such silanes, phosphor materials, or matrix materials, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, “attached” can refer to covalent or non-covalent interaction between two or more molecules. Non-covalent interactions can include ionic bonds, electrostatic interactions, van der Walls forces, dipole-dipole interactions, dipole-induced-dipole interactions, London dispersion forces, hydrogen bonding, halogen bonding, electromagnetic interactions, π-π interactions, cation-π interactions, anion-π interactions, polar π-interactions, and hydrophobic effects.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this disclosure belongs.

Reference to “a” chemical compound refers one or more molecules of the chemical compound, rather than being limited to a single molecule of the chemical compound. Furthermore, the one or more molecules may or may not be identical, so long as they fall under the category of the chemical compound. Thus, for example, “a” polyamide is interpreted to include one or more polymer molecules of the polyamide, where the polymer molecules may or may not be identical (e.g., different molecular weights and/or isomers).

As used herein, the term “units” can be used to refer to individual (co)monomer units such that, for example, styrenic repeat units refers to individual styrene (co)monomer units in the polymer. In addition, the term “units” can be used to refer to polymeric block units such that, for example, “styrene repeating units” can also refer to polystyrene blocks; “units of polyethylene” refers to block units of polyethylene; “units of polypropylene” refers to block units of polypropylene; “units of polybutylene” refers to block units of polybutylene, and so on. Such use will be clear from the context.

The term “copolymer” refers to a polymer having two or more monomer species, and includes terpolymers (i.e., copolymers having three monomer species).

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

As used herein the terms “volume percent,” “vol %,” “v/v %,” and “vol. %,” which can be used interchangeably, indicate the percent by volume of a given component based on the total volume of the composition, unless otherwise specified. That is, unless otherwise specified, all v/v % values are based on the total volume of the composition. It should be understood that the sum of v/v % values for all components in a disclosed composition or formulation are equal to 100.

As used herein, the term “vol/vol” is a volume ratio in which the first “vol” (numerator) refers to the volume of a component in a solution or mixture and the second “vol” (denominator) refers to the total volume of all components in the solution or mixture.

As used herein, the term “effective amount” refers to an amount that is sufficient to achieve the desired modification of a physical property of the composition or material. For example, an “effective amount” of a surface modifying material, such as silane coupling agent, refers to an amount that is sufficient to achieve the desired improvement in the property modulated by the formulation component, e.g. achieving the desired enhancement of dispersion in a matrix material, such as a polymer while retaining the desired level of photoluminescence. The specific level in terms of wt % in a composition required as an effective amount will depend upon a variety of factors including the amount and type of silane coupling agent, amount and type of phosphor material, amount and type of matrix material, and end use of the article made using the composition.

As used herein, the terms “phosphor powder coated with silane,” “surface-modified phosphor,” and “coated nanophosphor” can be used interchangeably and refer to the disclosed surface-modified phosphors prepared using the disclosed methods of preparing disclosed surface-modified phosphors, and as further described in the Examples herein.

As used herein, the terms “optional” or “optionally” means that the subsequently described event or circumstance can or cannot occur, and that the description includes instances where said event or circumstance occurs and instances where it does not.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, a residue of a silane coupling agent, i.e., a silane material, refers to the chemical moieties resulting from reaction of a silane coupling agent with a phosphor material.

The term “alkyl” as used herein is a branched or unbranched saturated hydrocarbon group of 1 to 100 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C60 alkyl. A “lower alkyl” group is an alkyl group containing from one to six carbon atoms. A “higher alkyl” group is an alkyl group containing from six to about 30 carbon atoms.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, cycloalkyl, alkoxy, amino, ether, halide, hydroxy, nitro, silyl, sulfo-oxo, or thiol as described herein.

The terms “alkoxy” and “alkoxyl” as used herein to refer to an alkyl or cycloalkyl group bonded through an ether linkage; that is, an “alkoxy” group can be defined as —OA¹ where A¹ is alkyl or cycloalkyl as defined above. “Alkoxy” also includes polymers of alkoxy groups as just described; that is, an alkoxy can be a polyether such as —OA¹-OA² or -OA¹-(OA²)ₐ-OA³, where “a” is an integer of from 1 to 200 and A¹, A², and A³ are alkyl and/or cycloalkyl groups.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The term “heterocycloalkenyl” is a type of cycloalkenyl group as defined above, and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aromatic group” as used herein refers to a ring structure having cyclic clouds of delocalized π electrons above and below the plane of the molecule, where the π clouds contain (4n+2) π electrons. A further discussion of aromaticity is found in Morrison and Boyd, Organic Chemistry, (5th Ed., 1987), Chapter 13, entitled “Aromaticity,” pages 477-497, incorporated herein by reference. The term “aromatic group” is inclusive of both aryl and heteroaryl groups.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl to two aryl groups that are bound together via a fused ring structure, as in naphthalene, or are attached via one or more carbon-carbon bonds, as in biphenyl.

The terms “amine” or “amino” as used herein are represented by the formula —NA¹A², where A¹ and A² can be, independently, hydrogen or alkyl, cycloalkyl, alkenyl, cycloalkenyl, alkynyl, cycloalkynyl, aryl, or heteroaryl group as described herein. A specific example of amino is —NH₂.

The term “alkylamino” as used herein is is inclusive of both monoalkylamino groups and dialkyl aminogroups. Monoalkylamino groups are represented by the formula —NH(-alkyl) where alkyl is a described herein. Representative examples of monoalkylamino groups include, but are not limited to, methylamino group, ethylamino group, propylamino group, isopropylamino group, butylamino group, isobutylamino group, (sec-butyl)amino group, (tert-butyl)amino group, pentylamino group, isopentylamino group, (tert-pentyl)amino group, hexylamino group, and the like. Dialkylamino groups are represented by the formula —N(-alkyl)₂ where alkyl is a described herein. Representative examples of dialkylamino groups include, but are not limited to, dimethylamino group, diethylamino group, dipropylamino group, diisopropylamino group, dibutylamino group, diisobutylamino group, di(sec-butyl)amino group, di(tert-butyl)amino group, dipentylamino group, diisopentylamino group, di(tert-pentyl)amino group, dihexylamino group, N-ethyl-N-methylamino group, N-methyl-N-propylamino group, N-ethyl-N-propylamino group and the like.

The terms “halo,” “halogen” or “halide,” as used herein can be used interchangeably and refer to F, Cl, Br, or I.

“R¹,” “R²,” “R³,” . . . “Rⁿ,” where n is an integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

As described herein, compounds of the disclosure may contain “optionally substituted” moieties. In general, the term “substituted,” whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this disclosure are preferably those that result in the formation of stable or chemically feasible compounds. In is also contemplated that, in certain aspects, unless expressly indicated to the contrary, individual substituents can be further optionally substituted (i.e., further substituted or unsubstituted).

Suitable monovalent substituents on a substitutable carbon atom of an “optionally substituted” group are independently halogen; —(CH₂)₀₋₄R^{∘}; —(CH₂)₀₋₄OR^{∘}; —O(CH₂)₀₋₄R^{∘}, —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O(CH₂)₀₋₁Ph which may be substituted with R^{∘}; —CH═CHPh, which may be substituted with R^{∘}; —(CH₂)₀₋₄O(CH₂)₀₋₁-pyridyl which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘})N(R^{∘})C(O)R^{∘}; —N(R^{∘})N(R^{∘})C(O)NR^{∘}₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂)₀₋₄SR—, SC(S)SR^{∘}; —(CH₂)₀₋₄SC(O)R^{∘}; —(CH₂)₀₋₄C(O)NR^{∘}₂; —C(S)NR^{∘}₂; —C(S)SR^{∘}; —(CH₂)₀₋₄OC(O)NR^{∘}₂; —C(O)N(OR^{∘})R^{∘}; —C(O)C(O)R^{∘}; —C(O)CH₂C(O)R^{∘}; —C(NOR^{∘})R^{∘}; —(CH₂)₀₋₄SSR^{∘}; —(CH₂)₀₋₄S(O)₂R^{∘}; —(CH₂)₀₋₄S(O)₂OR^{∘}; —(CH₂)₀₋₄OS(O)₂R^{∘}; —S(O)₂NR^{∘}₂; —(CH₂)₀₋₄S(O)R^{∘}; —N(R^{∘})S(O)₂NR^{∘}₂; —N(R^{∘})S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘})₂; SiR^{∘}₃; —(C₁₋₄ straight or branched alkylene)O—N(R^{∘})₂; or —(C₁₋₄ straight or branched alkylene)C(O)O—N(R^{∘})₂, wherein each R^{∘} may be substituted as defined below and is independently hydrogen, C₁₋₆ aliphatic, —CH₂Ph, —O(CH₂)₀₋₁Ph, —CH₂-(5-6 membered heteroaryl ring), or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or bicyclic ring having 0-4 heteroatoms independently selected from nitrogen, oxygen, or sulfur, which may be substituted as defined below.

Suitable monovalent substituents on R^{∘} (or the ring formed by taking two independent occurrences of R^{∘} together with their intervening atoms), are independently halogen, —(CH₂)₀₋₂R^{•}, -(haloR^{•}), —(CH₂)₀₋₂OH, —(CH₂)₀₋₂OR^{•}, —(CH₂)₀₋₂CH(OR^{•})₂; —O(haloR^{•}), —CN, —N₃, —(CH₂)₀₋₂C(O)R^{•}, —(CH₂)₀₋₂C(O)OH, —(CH₂)₀₋₂C(O)OR^{•}, —(CH₂)₀₋₂SR^{•}, —(CH₂)₀₋₂SH, —(CH₂)₀₋₂NH₂, —(CH₂)₀₋₂NHR^{•}, —(CH₂)₀₋₂NR^{∘}₂, —NO₂, —SiR^{•}₃, —OSiR^{•}₃, —C(O)SR^{•}, —(C₁₋₄ straight or branched alkylene)C(O)OR^{•}, or —SSR^{•} wherein each R^{•} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{∘} include ═O and =S.

Suitable divalent substituents on a saturated carbon atom of an “optionally substituted” group include the following: ═O, ═S, ═NNR*₂, =NNHC(O)R*, =NNHC(O)OR*, =NNHS(O)₂R*, =NR*, =NOR*, —O(C(R*₂))₂₋₃O—, or —S(C(R*₂))₂₋₃S—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R* include halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of R^{†} are independently halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

As used herein, the term “derivative” refers to a compound having a structure derived from the structure of a parent compound (e.g., a compound disclosed herein) and whose structure is sufficiently similar to those disclosed herein and based upon that similarity, would be expected by one skilled in the art to exhibit the same or similar activities and utilities as the claimed compounds, or to induce, as a precursor, the same or similar activities and utilities as the claimed compounds. Exemplary derivatives include salts, esters, amides, salts of esters or amides, and N-oxides of a parent compound.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Unless otherwise specified, temperatures referred to herein are based on atmospheric pressure (i.e. one atmosphere).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B—F, C-D, C-E, and C—F are considered disclosed. Likewise, any subset or combination of these is also disclosed. Thus, for example, the sub-group of A-E, B—F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Disclosed Surface-modified Phosphor.

In accordance with the purpose(s) of the present disclosure, as embodied and broadly described herein, the disclosure, in one aspect, relates to compositions comprising a surface-modified phosphor material comprising a phosphor material and a silane material. The surface-modified phosphor material comprises a silane material attached to the phosphor material. The disclosed surface-modified phosphor material comprising a phosphor material and a silane can be prepared by the methods of preparing as disclosed herein below.

As defined herein above, “attached” can refer to covalent or non-covalent interaction between two or more molecules. Non-covalent interactions can include ionic bonds, electrostatic interactions, van der Walls forces, dipole-dipole interactions, dipole-induced-dipole interactions, London dispersion forces, hydrogen bonding, halogen bonding, electromagnetic interactions, π-π interactions, cation-π interactions, anion-π interactions, polar π-interactions, and hydrophobic effects.

In various aspects, the disclosed surface-modified phosphor materials comprise a silane material and a phosphor material such that weight ratio of silane material to phosphor material, based on the total weight of the surface-modified phosphor material, that is from about 1:1 to about 5:3. In a further aspect, the disclosed surface-modified phosphor materials comprise a silane material and a phosphor material such that weight ratio of silane material to phosphor material, based on the total weight of the surface-modified phosphor material, that is from about 1:2 to about 2:1. In a still further aspect, the disclosed surface-modified phosphor materials comprise a silane material and a phosphor material such that weight ratio of silane material to phosphor material, based on the total weight of the surface-modified phosphor material, that is about 1:1.

In a further aspect, the surface-modified phosphor materials comprise a silane material and a phosphor material such that weight ratio of silane material to phosphor material, based on the total weight of the surface-modified phosphor material, of about 1:6, about 1:5, about 1:4, about 1:3, about 1:2, about 1:1, about 2:1, about 3:2, about 3:1, about 4:3, about 4:2, about 4:1, about 5:3; or any weight range within the foregoing weight ratio values; or any combination of the foregoing weight ratios.

In a further aspect, the disclosed surface-modified phosphor materials comprise a wt % of silane material, based on the total weight of the surface-modified phosphor material, which is from about 10 wt % to about 70 wt %. In a still further aspect, the disclosed surface-modified phosphor materials comprise a wt % of silane material, based on the total weight of the surface-modified phosphor material, which is from about 40 wt % to about 60 wt %. In a yet further aspect, the disclosed surface-modified phosphor materials comprise a wt % of silane material, based on the total weight of the surface-modified phosphor material, which is from about 45 wt % to about 65 wt %.

In a further aspect, the surface-modified phosphor materials comprise a wt % of silane material, based on the total weight of the surface-modified phosphor material, that is about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %; or any range encompassed by the foregoing values; or any combination of the foregoing values.

In a further aspect, the surface-modified phosphor materials comprise a wt % of phosphor material, based on the total weight of the surface-modified phosphor material, which is from about 30 wt % to about 90 wt %. In a still further aspect, the surface-modified phosphor materials comprise a wt % of phosphor material, based on the total weight of the surface-modified phosphor material, which is from about 40 wt % to about 60 wt %. In a further aspect, the surface-modified phosphor materials comprise a wt % of phosphor material, based on the total weight of the surface-modified phosphor material, which is from about 45 wt % to about 55 wt %.

In a further aspect, the surface-modified phosphor materials comprise a wt % of phosphor material, based on the total weight of the surface-modified phosphor material, that is about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %; or any range encompassed by the foregoing values; or any combination of the foregoing values.

In various aspects, the surface-modified phosphor materials have an average particle size of about 1 nm to about 5200 nm. In a further aspect, the surface-modified phosphor materials have an average particle size of about 2 nm to about 110 nm. In a still further aspect, the surface-modified phosphor materials have an average particle size of about 2 nm to about 21 nm. In a yet further aspect, the surface-modified phosphor materials have an average particle size of about 2 nm to about 11 nm.

In a further aspect, the surface-modified phosphor materials have an average particle size of about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 39 nm, about 40 nm, about 41 nm, about 42 nm, about 43 nm, about 44 nm, about 45 nm, about 46 nm, about 47 nm, about 48 nm, about 49 nm, about 50 nm, about 51 nm, about 52 nm, about 53 nm, about 54 nm, about 55 nm, about 56 nm, about 57 nm, about 58 nm, about 59 nm, about 60 nm, about 61 nm, about 62 nm, about 63 nm, about 64 nm, about 65 nm, about 66 nm, about 67 nm, about 68 nm, about 69 nm, about 70 nm, about 71 nm, about 72 nm, about 73 nm, about 74 nm, about 75 nm, about 76 nm, about 77 nm, about 78 nm, about 79 nm, about 80 nm, about 81 nm, about 82 nm, about 83 nm, about 84 nm, about 85 nm, about 86 nm, about 87 nm, about 88 nm, about 89 nm, about 90 nm, about 91 nm, about 92 nm, about 93 nm, about 94 nm, about 95 nm, about 96 nm, about 97 nm, about 98 nm, about 99 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, about 780 nm, about 790 nm, about 800 nm, about 810 nm, about 820 nm, about 830 nm, about 840 nm, about 850 nm, about 860 nm, about 870 nm, about 880 nm, about 890 nm, about 900 nm, about 910 nm, about 920 nm, about 930 nm, about 940 nm, about 950 nm, about 960 nm, about 970 nm, about 980 nm, about 990 nm, about 1000 nm; about 1100 nm, about 1110 nm, about 1120 nm, about 1130 nm, about 1140 nm, about 1150 nm, about 1160 nm, about 1170 nm, about 1180 nm, about 1190 nm, about 1200 nm, about 1210 nm, about 1220 nm, about 1230 nm, about 1240 nm, about 1250 nm, about 1260 nm, about 1270 nm, about 1280 nm, about 1290 nm, about 1300 nm, about 1310 nm, about 1320 nm, about 1330 nm, about 1340 nm, about 1350 nm, about 1360 nm, about 1370 nm, about 1380 nm, about 1390 nm, about 1400 nm, about 1410 nm, about 1420 nm, about 1430 nm, about 1440 nm, about 1450 nm, about 1460 nm, about 1470 nm, about 1480 nm, about 1490 nm, about 1500 nm, about 1510 nm, about 1520 nm, about 1530 nm, about 1540 nm, about 1550 nm, about 1560 nm, about 1570 nm, about 1580 nm, about 1590 nm, about 1600 nm, about 1610 nm, about 1620 nm, about 1630 nm, about 1640 nm, about 1650 nm, about 1660 nm, about 1670 nm, about 1680 nm, about 1690 nm, about 1700 nm, about 1710 nm, about 1720 nm, about 1730 nm, about 1740 nm, about 1750 nm, about 1760 nm, about 1770 nm, about 1780 nm, about 1790 nm, about 1800 nm, about 1810 nm, about 1820 nm, about 1830 nm, about 1840 nm, about 1850 nm, about 1860 nm, about 1870 nm, about 1880 nm, about 1890 nm, about 1900 nm, about 1910 nm, about 1920 nm, about 1930 nm, about 1940 nm, about 1950 nm, about 1960 nm, about 1970 nm, about 1980 nm, about 1990 nm, about 2000 nm, about 2100 nm, about 2110 nm, about 2120 nm, about 2130 nm, about 2140 nm, about 2150 nm, about 2160 nm, about 2170 nm, about 2180 nm, about 2190 nm, about 2200 nm, about 2210 nm, about 2220 nm, about 2230 nm, about 2240 nm, about 2250 nm, about 2260 nm, about 2270 nm, about 2280 nm, about 2290 nm, about 2300 nm, about 2310 nm, about 2320 nm, about 2330 nm, about 2340 nm, about 2350 nm, about 2360 nm, about 2370 nm, about 2380 nm, about 2390 nm, about 2400 nm, about 2410 nm, about 2420 nm, about 2430 nm, about 2440 nm, about 2450 nm, about 2460 nm, about 2470 nm, about 2480 nm, about 2490 nm, about 2500 nm, about 2510 nm, about 2520 nm, about 2530 nm, about 2540 nm, about 2550 nm, about 2560 nm, about 2570 nm, about 2580 nm, about 2590 nm, about 2600 nm, about 2610 nm, about 2620 nm, about 2630 nm, about 2640 nm, about 2650 nm, about 2660 nm, about 2670 nm, about 2680 nm, about 2690 nm, about 2700 nm, about 2710 nm, about 2720 nm, about 2730 nm, about 2740 nm, about 2750 nm, about 2760 nm, about 2770 nm, about 2780 nm, about 2790 nm, about 2800 nm, about 2810 nm, about 2820 nm, about 2830 nm, about 2840 nm, about 2850 nm, about 2860 nm, about 2870 nm, about 2880 nm, about 2890 nm, about 2900 nm, about 2910 nm, about 2920 nm, about 2930 nm, about 2940 nm, about 2950 nm, about 2960 nm, about 2970 nm, about 2980 nm, about 2990 nm, about 3000 nm, about 3100 nm, about 3110 nm, about 3120 nm, about 3130 nm, about 3140 nm, about 3150 nm, about 3160 nm, about 3170 nm, about 3180 nm, about 3190 nm, about 3200 nm, about 3210 nm, about 3220 nm, about 3230 nm, about 3240 nm, about 3250 nm, about 3260 nm, about 3270 nm, about 3280 nm, about 3290 nm, about 3300 nm, about 3310 nm, about 3320 nm, about 3330 nm, about 3340 nm, about 3350 nm, about 3360 nm, about 3370 nm, about 3380 nm, about 3390 nm, about 3400 nm, about 3410 nm, about 3420 nm, about 3430 nm, about 3440 nm, about 3450 nm, about 3460 nm, about 3470 nm, about 3480 nm, about 3490 nm, about 3500 nm, about 3510 nm, about 3520 nm, about 3530 nm, about 3540 nm, about 3550 nm, about 3560 nm, about 3570 nm, about 3580 nm, about 3590 nm, about 3600 nm, about 3610 nm, about 3620 nm, about 3630 nm, about 3640 nm, about 3650 nm, about 3660 nm, about 3670 nm, about 3680 nm, about 3690 nm, about 3700 nm, about 3710 nm, about 3720 nm, about 3730 nm, about 3740 nm, about 3750 nm, about 3760 nm, about 3770 nm, about 3780 nm, about 3790 nm, about 3800 nm, about 3810 nm, about 3820 nm, about 3830 nm, about 3840 nm, about 3850 nm, about 3860 nm, about 3870 nm, about 3880 nm, about 3890 nm, about 3900 nm, about 3910 nm, about 3920 nm, about 3930 nm, about 3940 nm, about 3950 nm, about 3960 nm, about 3970 nm, about 3980 nm, about 3990 nm, about 4000 nm, about 4100 nm, about 4110 nm, about 4120 nm, about 4130 nm, about 4140 nm, about 4150 nm, about 4160 nm, about 4170 nm, about 4180 nm, about 4190 nm, about 4200 nm, about 4210 nm, about 4220 nm, about 4230 nm, about 4240 nm, about 4250 nm, about 4260 nm, about 4270 nm, about 4280 nm, about 4290 nm, about 4300 nm, about 4310 nm, about 4320 nm, about 4330 nm, about 4340 nm, about 4350 nm, about 4360 nm, about 4370 nm, about 4380 nm, about 4390 nm, about 4400 nm, about 4410 nm, about 4420 nm, about 4430 nm, about 4440 nm, about 4450 nm, about 4460 nm, about 4470 nm, about 4480 nm, about 4490 nm, about 4500 nm, about 4510 nm, about 4520 nm, about 4530 nm, about 4540 nm, about 4550 nm, about 4560 nm, about 4570 nm, about 4580 nm, about 4590 nm, about 4600 nm, about 4610 nm, about 4620 nm, about 4630 nm, about 4640 nm, about 4650 nm, about 4660 nm, about 4670 nm, about 4680 nm, about 4690 nm, about 4700 nm, about 4710 nm, about 4720 nm, about 4730 nm, about 4740 nm, about 4750 nm, about 4760 nm, about 4770 nm, about 4780 nm, about 4790 nm, about 4800 nm, about 4810 nm, about 4820 nm, about 4830 nm, about 4840 nm, about 4850 nm, about 4860 nm, about 4870 nm, about 4880 nm, about 4890 nm, about 4900 nm, about 4910 nm, about 4920 nm, about 4930 nm, about 4940 nm, about 4950 nm, about 4960 nm, about 4970 nm, about 4980 nm, about 4990 nm, about 5000 nm, about 5100 nm, about 5110 nm, about 5120 nm, about 5130 nm, about 5140 nm, about 5150 nm, about 5160 nm, about 5170 nm, about 5180 nm, about 5190 nm, about 5200 nm; or any range encompassed by the foregoing values; or any combination of the foregoing values.

In various aspects, the surface-modified phosphor materials have a phosphor core surrounded by a surface-modified surface, e.g., a coating layer. In a further aspect, the coating layer surrounding the phosphor core has a coating layer thickness of about 1 nm to about 200 nm. In a still further aspect, the coating layer surrounding the phosphor core has a coating layer thickness of about 1 nm to about 100 nm. In a yet further aspect, the coating layer surrounding the phosphor core has a coating layer thickness of about 1 nm to about 50 nm.

In a further aspect, the coating layer surrounding the phosphor core has a coating layer thickness of about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 39 nm, about 40 nm, about 41 nm, about 42 nm, about 43 nm, about 44 nm, about 45 nm, about 46 nm, about 47 nm, about 48 nm, about 49 nm, about 50 nm, about 51 nm, about 52 nm, about 53 nm, about 54 nm, about 55 nm, about 56 nm, about 57 nm, about 58 nm, about 59 nm, about 60 nm, about 61 nm, about 62 nm, about 63 nm, about 64 nm, about 65 nm, about 66 nm, about 67 nm, about 68 nm, about 69 nm, about 70 nm, about 71 nm, about 72 nm, about 73 nm, about 74 nm, about 75 nm, about 76 nm, about 77 nm, about 78 nm, about 79 nm, about 80 nm, about 81 nm, about 82 nm, about 83 nm, about 84 nm, about 85 nm, about 86 nm, about 87 nm, about 88 nm, about 89 nm, about 90 nm, about 91 nm, about 92 nm, about 93 nm, about 94 nm, about 95 nm, about 96 nm, about 97 nm, about 98 nm, about 99 nm, about 100 nm; or any range encompassed by the foregoing values; or any combination of the foregoing values.

In various aspects, the photoluminescence of the surface-modified phosphor materials is about 1% to about 100% the photoluminescence of the same phosphor materials that are not surface-modified. In a further aspect, the photoluminescence of the surface-modified phosphor materials is about 10% to about 90% the photoluminescence of the same phosphor materials that are not surface-modified. In a still further aspect, the photoluminescence of the surface-modified phosphor materials is about 70% to about 100% the photoluminescence of the same phosphor materials that are not surface-modified. In a still further aspect, the photoluminescence of the surface-modified phosphor materials is about 80% to about 100% the photoluminescence of the same phosphor materials that are not surface-modified. In an even further aspect, the photoluminescence of the surface-modified phosphor materials is about 90% to about 100% the photoluminescence of the same phosphor materials that are not surface-modified.

In a further aspect, the photoluminescence of the surface-modified phosphor materials compared to the photoluminescence of the same phosphor materials that are not surface-modified is about about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%; or any range encompassed by the foregoing values; or any combination of the foregoing values.

### Methods of Preparing Disclosed Surface-Modified Phosphor Materials.

In various aspects, the present disclosure pertains to methods for providing a surface modification, e.g., providing a coating layer, to phosphors in which the surface coating comprises silane ligands attached to a phosphor and/or to one another forming a coating. The surface modification, e.g., a coating, increases the compatibility of the phosphor surface with a polymer matrix, and does so with minimal to no change in its luminescent properties.

In a further aspect, the present disclosure pertains to methods of preparing a surface-modified phosphor material, the method comprising: preparing a phosphor material mixture comprising a phosphor material and a liquid comprising a first alcohol; preparing a surface-modifying solution comprising a silane, water, and a second alcohol; preparing a surface-modifying phosphor reaction mixture by mixing the phosphor material mixture and the surface-modifying solution; and heating the surface-modifying phosphor reaction mixture; thereby forming the surface-modified phosphor material.

In a further aspect, the present disclosure pertains to methods of preparing a surface-modified phosphor material, the method comprising: preparing a phosphor material mixture consisting essentially of a phosphor material and a liquid comprising a first alcohol; preparing a surface-modifying solution consisting essentially of a silane, water, and a second alcohol; preparing a surface-modifying phosphor reaction mixture by mixing the phosphor material mixture and the surface-modifying solution; and heating the surface-modifying phosphor reaction mixture; thereby forming the surface-modified phosphor material.

In a further aspect, the present disclosure pertains to methods of preparing a surface-modified phosphor material, the method comprising: preparing a phosphor material mixture comprising a phosphor material and a liquid comprising a first alcohol; preparing a surface-modifying solution comprising a silane, water, and a second alcohol; preparing a surface-modifying phosphor reaction mixture by mixing the phosphor material mixture and the surface-modifying solution in an inert atmosphere; and heating the surface-modifying phosphor reaction mixture; thereby forming the surface-modified phosphor material.

In a further aspect, the present disclosure pertains to methods of preparing a surface-modified phosphor material, the method comprising: preparing a phosphor material mixture consisting essentially of a phosphor material and a liquid comprising a first alcohol; preparing a surface-modifying solution consisting essentially of a silane, water, and a second alcohol; preparing a surface-modifying phosphor reaction mixture by mixing the phosphor material mixture and the surface-modifying solution; and heating the surface-modifying phosphor reaction mixture in an inert atmosphere; thereby forming the surface-modified phosphor material.

In a further aspect, the present disclosure pertains to methods of preparing a surface-modified phosphor material, the method comprising: preparing a phosphor material mixture comprising a phosphor material and a liquid comprising a first alcohol; preparing a surface-modifying solution comprising a silane, water, and a second alcohol, wherein the surface-modifying solution has a pH of about 2 to about 6; preparing a surface-modifying phosphor reaction mixture by mixing the phosphor material mixture and the surface-modifying solution; and heating the surface-modifying phosphor reaction mixture; thereby forming the surface-modified phosphor material.

In a further aspect, the present disclosure pertains to methods of preparing a surface-modified phosphor material, the method comprising: preparing a phosphor material mixture consisting essentially of a phosphor material and a liquid comprising a first alcohol; preparing a surface-modifying solution consisting essentially of a silane, water, and a second alcohol, wherein the surface-modifying solution has a pH of about 2 to about 6; preparing a surface-modifying phosphor reaction mixture by mixing the phosphor material mixture and the surface-modifying solution; and heating the surface-modifying phosphor reaction mixture; thereby forming the surface-modified phosphor material.

In a further aspect, the present disclosure pertains to methods of preparing a surface-modified phosphor material, the method comprising: preparing a phosphor material mixture comprising a phosphor material and a liquid comprising a first alcohol; preparing a surface-modifying solution comprising a silane, water, and a second alcohol, wherein the surface-modifying solution has a pH of about 2 to about 6; preparing a surface-modifying phosphor reaction mixture by mixing the phosphor material mixture and the surface-modifying solution in an inert atmosphere; and heating the surface-modifying phosphor reaction mixture; thereby forming the surface-modified phosphor material.

In a further aspect, the present disclosure pertains to methods of preparing a surface-modified phosphor material, the method comprising: preparing a phosphor material mixture consisting essentially of a phosphor material and a liquid comprising a first alcohol; preparing a surface-modifying solution consisting essentially of a silane, water, and a second alcohol, wherein the surface-modifying solution has a pH of about 2 to about 6; preparing a surface-modifying phosphor reaction mixture by mixing the phosphor material mixture and the surface-modifying solution; and heating the surface-modifying phosphor reaction mixture in an inert atmosphere; thereby forming the surface-modified phosphor material.

In a further aspect, the present disclosure pertains to methods of preparing a surface-modified phosphor material, the method comprising: preparing a phosphor material mixture comprising a phosphor material and a liquid comprising a first alcohol; preparing a surface-modifying solution comprising a silane, water, and a second alcohol, wherein the surface-modifying solution has a pH of about 3 to about 5; preparing a surface-modifying phosphor reaction mixture by mixing the phosphor material mixture and the surface-modifying solution; and heating the surface-modifying phosphor reaction mixture; thereby forming the surface-modified phosphor material.

In a further aspect, the present disclosure pertains to methods of preparing a surface-modified phosphor material, the method comprising: preparing a phosphor material mixture consisting essentially of a phosphor material and a liquid comprising a first alcohol; preparing a surface-modifying solution consisting essentially of a silane, water, and a second alcohol, wherein the surface-modifying solution has a pH of about 3 to about 5; preparing a surface-modifying phosphor reaction mixture by mixing the phosphor material mixture and the surface-modifying solution; and heating the surface-modifying phosphor reaction mixture; thereby forming the surface-modified phosphor material.

In a further aspect, the present disclosure pertains to methods of preparing a surface-modified phosphor material, the method comprising: preparing a phosphor material mixture comprising a phosphor material and a liquid comprising a first alcohol; preparing a surface-modifying solution comprising a silane, water, and a second alcohol, wherein the surface-modifying solution has a pH of about 3 to about 5; preparing a surface-modifying phosphor reaction mixture by mixing the phosphor material mixture and the surface-modifying solution in an inert atmosphere; and heating the surface-modifying phosphor reaction mixture; thereby forming the surface-modified phosphor material.

In a further aspect, the present disclosure pertains to methods of preparing a surface-modified phosphor material, the method comprising: preparing a phosphor material mixture consisting essentially of a phosphor material and a liquid comprising a first alcohol; preparing a surface-modifying solution consisting essentially of a silane, water, and a second alcohol, wherein the surface-modifying solution has a pH of about 3 to about 5; preparing a surface-modifying phosphor reaction mixture by mixing the phosphor material mixture and the surface-modifying solution; and heating the surface-modifying phosphor reaction mixture in an inert atmosphere; thereby forming the surface-modified phosphor material.

In a further aspect, the method can be optionally performed in an alcoholic solution to prevent the oxidation of the sulfide phosphor. For example, as discussed above, the phosphor material mixture comprises a phosphor material and a liquid comprising a first alcohol. Moreover, as discussed above, the surface-modifying solution comprises a silane, water, and a second alcohol. In some instances, the first alcohol and the second alcohol can be the same alcohol. In other instances, the first alcohol and the second alcohol can be different alcohols. The first alcohol can be any convenient alcohol, e.g., a short chain alkyl alcohol such as a C1-C10 alkyl alcohol. Non-limiting examples of suitable first alcohols are methanol, ethanol, propanol, isopropanol, and mixtures thereof. The second alcohol can be any convenient alcohol, e.g., a short chain alkyl alcohol such as a C1-C10 alkyl alcohol. Non-limiting examples of suitable second alcohols are methanol, ethanol, propanol, isopropanol, and mixtures thereof.

In a further aspect, the method be optionally carried out in an acidic medium to accelerate the hydrolysis of the silane coupling agent, e.g., at an acidic pH of about 2 to about 6, to accelerate the hydrolysis of the silane material.

In a further aspect, the pH of the surface-modifying solution has a pH of about 2 to about 6. In a still further aspect, the pH of the surface-modifying solution has a pH of about 3 to about 5. The pH of the surface-modifying solution can be adjusted to an appropriate pH after mixing the second alcohol and the silane material, e.g., by adjusting the pH using HCl, sulfuric acid, acetic acid, phosphoric acid, nitric acid, or combinations thereof.

In a further aspect, the pH of the surface-modifying solution has a pH of about 2.0, a pH of about 2.1, a pH of about 2.2, a pH of about 2.3, a pH of about 2.4, a pH of about 2.5, a pH of about 2.6, a pH of about 2.7, a pH of about 2.8, a pH of about 2.9, a pH of about 3.0, a pH of about 3.1, a pH of about 3.2, a pH of about 3.3, a pH of about 3.4, a pH of about 3.5, a pH of about 3.6, a pH of about 3.7, a pH of about 3.8, a pH of about 3.9, a pH of about 4.0, a pH of about 4.1, a pH of about 4.2, a pH of about 4.3, a pH of about 4.4, a pH of about 4.5, a pH of about 4.6, a pH of about 4.7, a pH of about 4.8, a pH of about 4.9, a pH of about 5.0, a pH of about 5.1, a pH of about 5.2, a pH of about 5.3, a pH of about 5.4, a pH of about 5.5, a pH of about 5.6, a pH of about 5.7, a pH of about 5.8, a pH of about 5.9, a pH of about 6.0; or any range encompassed by the foregoing values; or any combination of the foregoing values.

In a further aspect, the pH of the surface-modifying phosphor reaction mixture has a pH of about 2 to about 6. In a still further aspect, the pH of the surface-modifying phosphor reaction mixture has a pH of about 3 to about 5. The pH of the surface-modifying phosphor reaction mixture can be adjusted to an appropriate pH after mixing the second alcohol and the silane material, e.g., by adjusting the pH using HCl, sulfuric acid, acetic acid, phosphoric acid, nitric acid, or combinations thereof.

In a further aspect, the pH of the surface-modifying phosphor reaction mixture has a pH of about 2.0, a pH of about 2.1, a pH of about 2.2, a pH of about 2.3, a pH of about 2.4, a pH of about 2.5, a pH of about 2.6, a pH of about 2.7, a pH of about 2.8, a pH of about 2.9, a pH of about 3.0, a pH of about 3.1, a pH of about 3.2, a pH of about 3.3, a pH of about 3.4, a pH of about 3.5, a pH of about 3.6, a pH of about 3.7, a pH of about 3.8, a pH of about 3.9, a pH of about 4.0, a pH of about 4.1, a pH of about 4.2, a pH of about 4.3, a pH of about 4.4, a pH of about 4.5, a pH of about 4.6, a pH of about 4.7, a pH of about 4.8, a pH of about 4.9, a pH of about 5.0, a pH of about 5.1, a pH of about 5.2, a pH of about 5.3, a pH of about 5.4, a pH of about 5.5, a pH of about 5.6, a pH of about 5.7, a pH of about 5.8, a pH of about 5.9, a pH of about 6.0; or any range encompassed by the foregoing values; or any combination of the foregoing values.

In a further aspect, the method can be carried out under an inert atmosphere, e.g., nitrogen, argon, and combinations thereof.

In various aspects, the phosphor material mixture comprises a phosphor at a concentration of about 1 mg/ml to about 50 mg/ml. In a further aspect, the phosphor material mixture comprises a phosphor at a concentration of about 1 mg/ml to about 20 mg/ml. In a still further aspect, the phosphor material mixture comprises a phosphor at a concentration of about 1 mg/ml to about 10 mg/ml. In a yet further aspect, the phosphor material mixture comprises a phosphor at a concentration of about 2.5 mg/ml to about 7.5 mg/ml. In a yet further aspect, the phosphor material comprises a phosphor at a concentration of about 3.0 mg/ml to about 6.0 mg/ml.

In a further aspect, the phosphor material mixture comprises a phosphor at a concentration of about 1 mg/ml, about 2 mg/ml, about 3 mg/ml, about 4 mg/ml, about 5 mg/ml, about 6 mg/ml, about 7 mg/ml, about 8 mg/ml, about 9 mg/ml, about 10 mg/ml, about 11 mg/ml, about 12 mg/ml, about 13 mg/ml, about 14 mg/ml, about 15 mg/ml, about 16 mg/ml, about 17 mg/ml, about 18 mg/ml, about 19 mg/ml, about 20 mg/ml, about 21 mg/ml, about 22 mg/ml, about 23 mg/ml, about 24 mg/ml, about 25 mg/ml, about 26 mg/ml, about 27 mg/ml, about 28 mg/ml, about 29 mg/ml, about 30 mg/ml, about 31 mg/ml, about 32 mg/ml, about 33 mg/ml, about 34 mg/ml, about 35 mg/ml, about 36 mg/ml, about 37 mg/ml, about 38 mg/ml, about 39 mg/ml, about 40 mg/ml, about 41 mg/ml, about 42 mg/ml, about 43 mg/ml, about 44 mg/ml, about 45 mg/ml, about 46 mg/ml, about 47 mg/ml, about 48 mg/ml, about 49 mg/ml, about 50 mg/ml; or any range encompassed by the foregoing values; or any combination of the foregoing values.

In a further aspect, the surface-modifying solution comprising a silane, water, and a second alcohol comprises the silane at a v/v concentration, based on the total volume of the surface-modifying solution, of about 0.0025 to about 2.5. In a still further aspect, the surface-modifying solution comprising a silane, water, and a second alcohol comprises the silane at a v/v concentration, based on the total volume of the surface-modifying solution, of about 0.005 to about 0.25. In a yet further aspect, the surface-modifying solution comprising the silane, water, and a second alcohol comprises the silane at a v/v concentration, based on the total volume of the surface-modifying solution, of about 0.025 to about 0.15. In an even further aspect, the surface-modifying solution comprising a silane, water, and a second alcohol comprises the silane at a v/v concentration, based on the total volume of the surface-modifying solution, of about 0.050 to about 0.125.

In a further aspect, the surface-modifying solution comprising a silane, water, and a second alcohol comprises the silane at a v/v concentration, based on the total volume of the surface-modifying solution, of about 0.0025, about 0.0026, about 0.0027, about 0.0028, about 0.0029, about 0.0030, about 0.0031, about 0.0032, about 0.0033, about 0.0034, about 0.0035, about 0.0036, about 0.0037, about 0.0038, about 0.0039, about 0.0040, about 0.0041, about 0.0042, about 0.0043, about 0.0044, about 0.0045, about 0.0046, about 0.0047, about 0.0048, about 0.0049, about 0.0050, about 0.0051, about 0.0052, about 0.0053, about 0.0054, about 0.0055, about 0.0056, about 0.0057, about 0.0058, about 0.0059, about 0.0060, about 0.0061, about 0.0062, about 0.0063, about 0.0064, about 0.0065, about 0.0066, about 0.0067, about 0.0068, about 0.0069, about 0.0070, about 0.0071, about 0.0072, about 0.0073, about 0.0074, about 0.0075, about 0.0076, about 0.0077, about 0.0078, about 0.0079, about 0.0080, about 0.0081, about 0.0082, about 0.0083, about 0.0084, about 0.0085, about 0.0086, about 0.0087, about 0.0088, about 0.0089, about 0.0090, about 0.0091, about 0.0092, about 0.0093, about 0.0094, about 0.0095, about 0.0096, about 0.0097, about 0.0098, about 0.0099, about 0.010, about 0.011, about 0.012, about 0.013, about 0.014, about 0.015, about 0.016, about 0.017, about 0.018, about 0.019, about 0.020, about 0.021, about 0.022, about 0.023, about 0.024, about 0.025, about 0.026, about 0.027, about 0.028, about 0.029, about 0.030, about 0.031, about 0.032, about 0.033, about 0.034, about 0.035, about 0.036, about 0.037, about 0.038, about 0.039, about 0.040, about 0.041, about 0.042, about 0.043, about 0.044, about 0.045, about 0.046, about 0.047, about 0.048, about 0.049, about 0.050, about 0.051, about 0.052, about 0.053, about 0.054, about 0.055, about 0.056, about 0.057, about 0.058, about 0.059, about 0.060, about 0.061, about 0.062, about 0.063, about 0.064, about 0.065, about 0.066, about 0.067, about 0.068, about 0.069, about 0.070, about 0.071, about 0.072, about 0.073, about 0.074, about 0.075, about 0.076, about 0.077, about 0.078, about 0.079, about 0.080, about 0.081, about 0.082, about 0.083, about 0.084, about 0.085, about 0.086, about 0.087, about 0.088, about 0.089, about 0.090, about 0.091, about 0.092, about 0.093, about 0.094, about 0.095, about 0.096, about 0.097, about 0.098, about 0.099, about 0.100, about 0.101, about 0.102, about 0.103, about 0.104, about 0.105, about 0.106, about 0.0107, about 0.108, about 0.109, about 0.110, about 0.111, about 0.112, about 0.113, about 0.114, about 0.115, about 0.116, about 0.117, about 0.118, about 0.119, about 0.120, about 0.121, about 0.122, about 0.123, about 0.124, about 0.125, about 0.126, about 0.127, about 0.128, about 0.129, about 0.130, about 0.131, about 0.132, about 0.133, about 0.134, about 0.135, about 0.136, about 0.137, about 0.138, about 0.139, about 0.140, about 0.141, about 0.142, about 0.143, about 0.144, about 0.145, about 0.146, about 0.147, about 0.148, about 0.149, about 0.150, about 0.151, about 0.152, about 0.153, about 0.154, about 0.155, about 0.156, about 0.157, about 0.158, about 0.159, about 0.160, about 0.161, about 0.162, about 0.163, about 0.164, about 0.165, about 0.166, about 0.167, about 0.168, about 0.169, about 0.170, about 0.171, about 0.172, about 0.173, about 0.174, about 0.175, about 0.176, about 0.177, about 0.178, about 0.179, about 0.180, about 0.181, about 0.182, about 0.183, about 0.184, about 0.185, about 0.186, about 0.187, about 0.188, about 0.189, about 0.190, about 0.191, about 0.192, about 0.193, about 0.194, about 0.195, about 0.196, about 0.197, about 0.198, about 0.199, about 0.20, about 0.21, about 0.22, about 0.23, about 0.24, about 0.25, about 0.26, about 0.27, about 0.28, about 0.29, about 0.30, about 0.31, about 0.32, about 0.33, about 0.34, about 0.35, about 0.36, about 0.37, about 0.38, about 0.39, about 0.40, about 0.41, about 0.42, about 0.43, about 0.44, about 0.45, about 0.46, about 0.47, about 0.48, about 0.49, about 0.50; or any range encompassed by the foregoing values; or any combination of the foregoing values.

In a further aspect, the surface-modifying solution comprising a silane, water, and a second alcohol comprises water at a v/v concentration, based on the total volume of the surface-modifying solution, of about 0.4 to about 0.9. In a still further aspect, the surface-modifying solution comprising t silane, water, and a second alcohol comprises water at a v/v concentration, based on the total volume of the surface-modifying solution, of about 0.5 to about 0.85. In a yet further aspect, the surface-modifying solution comprising a silane, water, and a second alcohol comprises water at a v/v concentration, based on the total volume of the surface-modifying solution, of about 0.55 to about 0.85. In an even further aspect, the surface-modifying solution comprising a silane, water, and a second alcohol comprises water at a v/v concentration, based on the total volume of the surface-modifying solution, of about 0.70 to about 0.85.

In a further aspect, the surface-modifying solution comprising a silane, water, and a second alcohol comprises water at a v/v concentration, based on the total volume of the surface-modifying solution, of about 0.40, about 0.41, about 0.42, about 0.43, about 0.44, about 0.45, about 0.46, about 0.47, about 0.48, about 0.49, about 0.50, about 0.50, about 0.51, about 0.52, about 0.53, about 0.54, about 0.55, about 0.56, about 0.57, about 0.58, about 0.59, about 0.60, about 0.61, about 0.62, about 0.63, about 0.64, about 0.65, about 0.66, about 0.67, about 0.68, about 0.69, about 0.70, about 0.71, about 0.72, about 0.73, about 0.74, about 0.75, about 0.76, about 0.77, about 0.78, about 0.79, about 0.80, about 0.81, about 0.82, about 0.83, about 0.84, about 0.85, about 0.86, about 0.87, about 0.88, about 0.89, about 0.90; or any range encompassed by the foregoing values; or any combination of the foregoing values.

In a further aspect, the surface-modifying solution comprising a silane, water, and a second alcohol comprises the second alcohol at a v/v concentration, based on the total volume of the surface-modifying solution, of about 0.01 to about 0.3. In a still further aspect, the surface-modifying solution comprising a silane, water, and a second alcohol comprises the second alcohol at a v/v concentration, based on the total volume of the surface-modifying solution, of about 0.01 to about 0.20. In a yet further aspect, the surface-modifying solution comprising a silane, water, and a second alcohol comprises the second alcohol at a v/v concentration, based on the total volume of the surface-modifying solution, of about 0.05 to about 0.20. In an even further aspect, the surface-modifying solution comprising a silane, water, and a second alcohol comprises the second alcohol at a v/v concentration, based on the total volume of the surface-modifying solution, of about 0.05 to about 0.15.

In a further aspect, the surface-modifying solution comprising a silane, water, and a second alcohol comprises the second alcohol at a v/v concentration, based on the total volume of the surface-modifying solution, of about 0.011, about 0.012, about 0.013, about 0.014, about 0.015, about 0.016, about 0.017, about 0.018, about 0.019, about 0.020, about 0.021, about 0.022, about 0.023, about 0.024, about 0.025, about 0.026, about 0.027, about 0.028, about 0.029, about 0.030, about 0.031, about 0.032, about 0.033, about 0.034, about 0.035, about 0.036, about 0.037, about 0.038, about 0.039, about 0.040, about 0.041, about 0.042, about 0.043, about 0.044, about 0.045, about 0.046, about 0.047, about 0.048, about 0.049, about 0.050, about 0.051, about 0.052, about 0.053, about 0.054, about 0.055, about 0.056, about 0.057, about 0.058, about 0.059, about 0.060, about 0.061, about 0.062, about 0.063, about 0.064, about 0.065, about 0.066, about 0.067, about 0.068, about 0.069, about 0.070, about 0.071, about 0.072, about 0.073, about 0.074, about 0.075, about 0.076, about 0.077, about 0.078, about 0.079, about 0.080, about 0.081, about 0.082, about 0.083, about 0.084, about 0.085, about 0.086, about 0.087, about 0.088, about 0.089, about 0.090, about 0.091, about 0.092, about 0.093, about 0.094, about 0.095, about 0.096, about 0.097, about 0.098, about 0.099, about 0.100, about 0.101, about 0.102, about 0.103, about 0.104, about 0.105, about 0.106, about 0.0107, about 0.108, about 0.109, about 0.110, about 0.111, about 0.112, about 0.113, about 0.114, about 0.115, about 0.116, about 0.117, about 0.118, about 0.119, about 0.120, about 0.121, about 0.122, about 0.123, about 0.124, about 0.125, about 0.126, about 0.127, about 0.128, about 0.129, about 0.130, about 0.131, about 0.132, about 0.133, about 0.134, about 0.135, about 0.136, about 0.137, about 0.138, about 0.139, about 0.140, about 0.141, about 0.142, about 0.143, about 0.144, about 0.145, about 0.146, about 0.147, about 0.148, about 0.149, about 0.150, about 0.151, about 0.152, about 0.153, about 0.154, about 0.155, about 0.156, about 0.157, about 0.158, about 0.159, about 0.160, about 0.161, about 0.162, about 0.163, about 0.164, about 0.165, about 0.166, about 0.167, about 0.168, about 0.169, about 0.170, about 0.171, about 0.172, about 0.173, about 0.174, about 0.175, about 0.176, about 0.177, about 0.178, about 0.179, about 0.180, about 0.181, about 0.182, about 0.183, about 0.184, about 0.185, about 0.186, about 0.187, about 0.188, about 0.189, about 0.190, about 0.191, about 0.192, about 0.193, about 0.194, about 0.195, about 0.196, about 0.197, about 0.198, about 0.199, about 0.20, about 0.21, about 0.22, about 0.23, about 0.24, about 0.25, about 0.26, about 0.27, about 0.28, about 0.29, about 0.30; or any range encompassed by the foregoing values; or any combination of the foregoing values.

In a further aspect, the surface-modifying phosphor reaction mixture comprises the silane at a v/v concentration, based on the total volume of the surface-modifying phosphor reaction mixture, of about 0.0005 to about 0.5. In a still further aspect, the surface-modifying phosphor reaction mixture comprises the silane at a v/v concentration, based on the total volume of the surface-modifying phosphor reaction mixture, of about 0.001 to about 0.05. In a yet further aspect, the surface-modifying phosphor reaction mixture comprises the silane at a v/v concentration, based on the total volume of the surface-modifying phosphor reaction mixture, of about 0.005 to about 0.03. In an even further aspect, the surface-modifying phosphor reaction mixture comprises the silane at a v/v concentration, based on the total volume of the surface-modifying phosphor reaction mixture, of about 0.010 to about 0.025.

In a further aspect, the surface-modifying phosphor reaction mixture comprises the silane at a v/v concentration, based on the total volume of the surface-modifying phosphor reaction mixture, of about about 0.0005, about 0.0006, about 0.0007, about 0.0008, about 0.0009, about 0.0010, about 0.0011, about 0.0012, about 0.0013, about 0.0014, about 0.0015, about 0.0016, about 0.0017, about 0.0018, about 0.0019, about 0.0020, about 0.0021, about 0.0022, about 0.0023, about 0.0024, about 0.0025, about 0.0026, about 0.0027, about 0.0028, about 0.0029, about 0.0030, about 0.0031, about 0.0032, about 0.0033, about 0.0034, about 0.0035, about 0.0036, about 0.0037, about 0.0038, about 0.0039, about 0.0040, about 0.0041, about 0.0042, about 0.0043, about 0.0044, about 0.0045, about 0.0046, about 0.0047, about 0.0048, about 0.0049, about 0.0050, about 0.0051, about 0.0052, about 0.0053, about 0.0054, about 0.0055, about 0.0056, about 0.0057, about 0.0058, about 0.0059, about 0.0060, about 0.0061, about 0.0062, about 0.0063, about 0.0064, about 0.0065, about 0.0066, about 0.0067, about 0.0068, about 0.0069, about 0.0070, about 0.0071, about 0.0072, about 0.0073, about 0.0074, about 0.0075, about 0.0076, about 0.0077, about 0.0078, about 0.0079, about 0.0080, about 0.0081, about 0.0082, about 0.0083, about 0.0084, about 0.0085, about 0.0086, about 0.0087, about 0.0088, about 0.0089, about 0.0090, about 0.0091, about 0.0092, about 0.0093, about 0.0094, about 0.0095, about 0.0096, about 0.0097, about 0.0098, about 0.0099, about 0.010, about 0.011, about 0.012, about 0.013, about 0.014, about 0.015, about 0.016, about 0.017, about 0.018, about 0.019, about 0.020, about 0.021, about 0.022, about 0.023, about 0.024, about 0.025, about 0.026, about 0.027, about 0.028, about 0.029, about 0.030, about 0.031, about 0.032, about 0.033, about 0.034, about 0.035, about 0.036, about 0.037, about 0.038, about 0.039, about 0.040, about 0.041, about 0.042, about 0.043, about 0.044, about 0.045, about 0.046, about 0.047, about 0.048, about 0.049, about 0.050, about 0.051, about 0.052, about 0.053, about 0.054, about 0.055, about 0.056, about 0.057, about 0.058, about 0.059, about 0.060, about 0.061, about 0.062, about 0.063, about 0.064, about 0.065, about 0.066, about 0.067, about 0.068, about 0.069, about 0.070, about 0.071, about 0.072, about 0.073, about 0.074, about 0.075, about 0.076, about 0.077, about 0.078, about 0.079, about 0.080, about 0.081, about 0.082, about 0.083, about 0.084, about 0.085, about 0.086, about 0.087, about 0.088, about 0.089, about 0.090, about 0.091, about 0.092, about 0.093, about 0.094, about 0.095, about 0.096, about 0.097, about 0.098, about 0.099, about 0.100, about 0.101, about 0.102, about 0.103, about 0.104, about 0.105, about 0.106, about 0.0107, about 0.108, about 0.109, about 0.110, about 0.111, about 0.112, about 0.113, about 0.114, about 0.115, about 0.116, about 0.117, about 0.118, about 0.119, about 0.120, about 0.121, about 0.122, about 0.123, about 0.124, about 0.125, about 0.126, about 0.127, about 0.128, about 0.129, about 0.130, about 0.131, about 0.132, about 0.133, about 0.134, about 0.135, about 0.136, about 0.137, about 0.138, about 0.139, about 0.140, about 0.141, about 0.142, about 0.143, about 0.144, about 0.145, about 0.146, about 0.147, about 0.148, about 0.149, about 0.150, about 0.151, about 0.152, about 0.153, about 0.154, about 0.155, about 0.156, about 0.157, about 0.158, about 0.159, about 0.160, about 0.161, about 0.162, about 0.163, about 0.164, about 0.165, about 0.166, about 0.167, about 0.168, about 0.169, about 0.170, about 0.171, about 0.172, about 0.173, about 0.174, about 0.175, about 0.176, about 0.177, about 0.178, about 0.179, about 0.180, about 0.181, about 0.182, about 0.183, about 0.184, about 0.185, about 0.186, about 0.187, about 0.188, about 0.189, about 0.190, about 0.191, about 0.192, about 0.193, about 0.194, about 0.195, about 0.196, about 0.197, about 0.198, about 0.199, about 0.20, about 0.21, about 0.22, about 0.23, about 0.24, about 0.25, about 0.26, about 0.27, about 0.28, about 0.29, about 0.30, about 0.31, about 0.32, about 0.33, about 0.34, about 0.35, about 0.36, about 0.37, about 0.38, about 0.39, about 0.40, about 0.41, about 0.42, about 0.43, about 0.44, about 0.45, about 0.46, about 0.47, about 0.48, about 0.49, about 0.50; or any range encompassed by the foregoing values; or any combination of the foregoing values.

In a further aspect, the surface-modifying phosphor reaction mixture comprises water at a v/v concentration, based on the total volume of the surface-modifying phosphor reaction mixture, of about 0.01 to about 0.20. In a still further aspect, the surface-modifying phosphor reaction mixture comprises water at a v/v concentration, based on the total volume of the surface-modifying phosphor reaction mixture, of about 0.05 to about 0.15. In a yet further aspect, the surface-modifying phosphor reaction mixture comprises water at a v/v concentration, based on the total volume of the surface-modifying phosphor reaction mixture, of about 0.10 to about 0.20. In an even further aspect, the surface-modifying phosphor reaction mixture comprises water at a v/v concentration, based on the total volume of the surface-modifying phosphor reaction mixture, of about 0.125 to about 0.175.

In a further aspect, the surface-modifying phosphor reaction mixture comprises water at a v/v concentration, based on the total volume of the surface-modifying phosphor reaction mixture, of about 0.010, about 0.011, about 0.012, about 0.013, about 0.014, about 0.015, about 0.016, about 0.017, about 0.018, about 0.019, about 0.020, about 0.021, about 0.022, about 0.023, about 0.024, about 0.025, about 0.026, about 0.027, about 0.028, about 0.029, about 0.030, about 0.031, about 0.032, about 0.033, about 0.034, about 0.035, about 0.036, about 0.037, about 0.038, about 0.039, about 0.040, about 0.041, about 0.042, about 0.043, about 0.044, about 0.045, about 0.046, about 0.047, about 0.048, about 0.049, about 0.050, about 0.051, about 0.052, about 0.053, about 0.054, about 0.055, about 0.056, about 0.057, about 0.058, about 0.059, about 0.060, about 0.061, about 0.062, about 0.063, about 0.064, about 0.065, about 0.066, about 0.067, about 0.068, about 0.069, about 0.070, about 0.071, about 0.072, about 0.073, about 0.074, about 0.075, about 0.076, about 0.077, about 0.078, about 0.079, about 0.080, about 0.081, about 0.082, about 0.083, about 0.084, about 0.085, about 0.086, about 0.087, about 0.088, about 0.089, about 0.090, about 0.091, about 0.092, about 0.093, about 0.094, about 0.095, about 0.096, about 0.097, about 0.098, about 0.099, about 0.100, about 0.101, about 0.102, about 0.103, about 0.104, about 0.105, about 0.106, about 0.0107, about 0.108, about 0.109, about 0.110, about 0.111, about 0.112, about 0.113, about 0.114, about 0.115, about 0.116, about 0.117, about 0.118, about 0.119, about 0.120, about 0.121, about 0.122, about 0.123, about 0.124, about 0.125, about 0.126, about 0.127, about 0.128, about 0.129, about 0.130, about 0.131, about 0.132, about 0.133, about 0.134, about 0.135, about 0.136, about 0.137, about 0.138, about 0.139, about 0.140, about 0.141, about 0.142, about 0.143, about 0.144, about 0.145, about 0.146, about 0.147, about 0.148, about 0.149, about 0.150, about 0.151, about 0.152, about 0.153, about 0.154, about 0.155, about 0.156, about 0.157, about 0.158, about 0.159, about 0.160, about 0.161, about 0.162, about 0.163, about 0.164, about 0.165, about 0.166, about 0.167, about 0.168, about 0.169, about 0.170, about 0.171, about 0.172, about 0.173, about 0.174, about 0.175, about 0.176, about 0.177, about 0.178, about 0.179, about 0.180, about 0.181, about 0.182, about 0.183, about 0.184, about 0.185, about 0.186, about 0.187, about 0.188, about 0.189, about 0.190, about 0.191, about 0.192, about 0.193, about 0.194, about 0.195, about 0.196, about 0.197, about 0.198, about 0.199, about 0.20; or any range encompassed by the foregoing values; or any combination of the foregoing values.

In a further aspect, the surface-modifying phosphor reaction mixture comprises the first and second alcohol at a v/v concentration, based on the total volume of the surface-modifying phosphor reaction mixture, of about 0.40 to about 0.95. In a still further aspect, the surface-modifying phosphor reaction mixture comprises the first and second alcohol at a v/v concentration at a v/v concentration, based on the total volume of the surface-modifying phosphor reaction mixture, of about 0.55 to about 0.90. In a yet further aspect, the surface-modifying phosphor reaction mixture comprises the first and second alcohol at a v/v concentration at a v/v concentration, based on the total volume of the surface-modifying phosphor reaction mixture, of about 0.70 to about 0.90. In an even further aspect, the surface-modifying phosphor reaction mixture comprises the first and second alcohol at a v/v concentration at a v/v concentration, based on the total volume of the surface-modifying phosphor reaction mixture, of about 0.80 to about 0.90.

In a further aspect, the surface-modifying phosphor reaction mixture comprises the first and second alcohol at a v/v concentration, based on the total volume of the surface-modifying phosphor reaction mixture, of about 0.40, about 0.41, about 0.42, about 0.43, about 0.44, about 0.45, about 0.46, about 0.47, about 0.48, about 0.49, about 0.50, about 0.50, about 0.51, about 0.52, about 0.53, about 0.54, about 0.55, about 0.56, about 0.57, about 0.58, about 0.59, about 0.60, about 0.61, about 0.62, about 0.63, about 0.64, about 0.65, about 0.66, about 0.67, about 0.68, about 0.69, about 0.70, about 0.71, about 0.72, about 0.73, about 0.74, about 0.75, about 0.76, about 0.77, about 0.78, about 0.79, about 0.80, about 0.81, about 0.82, about 0.83, about 0.84, about 0.85, about 0.86, about 0.87, about 0.88, about 0.89, about 0.90, about 0.91, about 0.92, about 0.93, about 0.94, about 0.95; or any range encompassed by the foregoing values; or any combination of the foregoing values.

The surface-modified phosphor materials comprise a phosphor material, as disclosed herein throughout, and a surface-modification thereto comprising a silane material, as disclosed herein throughout. In some aspects, the surface-modification comprising a disclosed silane materials comprises a disclosed silane material that is attached to a disclosed phosphor as “attached” is understood and defined herein. In various aspects, the silane material may form a coating surrounding the phosphor material. In some aspects, the silane material can form covalent linkages within the silane material and/or attach to the phosphor material. In some instances, the phosphor used in the disclosed method is a sulfide phosphor, including, but not limited to, a calcium sulfide (CaS), strontium sulfide (SrS), cadmium sulfide (CdS), zinc sulfide (ZnS) and any combination thereof. The sulfide phosphor may be doped with at least one rare earth ion selected from Eu, Tb, Ce, Dy, Sm, Yb and Er.

The silane coupling agent used in the disclosed methods for attaching to and/or coating a sulfide phosphor can be an organosilane, but not limited to, for example alkyl silanes, methyl silane, alkoxysilanes, 3-methacryloxypropyltrimethoxysilane, vinyltrimethoxysilane, (3-mercaptopropyl)trimethoxysilane, (3-trimethoxysilyl)propyl methacrylate, 3-(methacryloyloxy)propyldimethylethoxysilane, 3-(methacryloyloxy)propenyltrimethoxysilane, 3-(methacryloyloxy)propyltrimethoxysilane, or combinations thereof. Preferably the silane coupling agent may include long chain hydrocarbons. In a further aspect, the silane coupling agent is (3-mercaptopropyl)trimethoxysilane and (3-trimethoxysilyl)propyl methacrylate, or combinations thereof.

In various aspects, the heating of the surface-modifying phosphor reaction mixture can be carried out at about 10 degrees Celsius to about 70 degrees Celsius. In a further aspect, the heating of the surface-modifying phosphor reaction mixture can be carried out at about 15 degrees Celsius to about 40 degrees Celsius. In a still further aspect, the heating of the surface-modifying phosphor reaction mixture can be carried out at about 15 degrees Celsius to about 30 degrees Celsius. In a yet further aspect, the heating of the surface-modifying phosphor reaction mixture can be carried out at about 15 degrees Celsius to about 25 degrees Celsius. In an even further aspect, the heating of the surface-modifying phosphor reaction mixture can be carried out at about 10 degrees Celsius to about 25 degrees Celsius.

In various aspects, the disclosed method of preparing a surface-modified phosphor material can further comprise removing a liquid phase from the surface-modified phosphor material, e.g., by centrifugation, filtration, decantation, or other methods known to the skilled artisan. Following removal of the liquid phase, the surface-modified phosphor material can be dried.

In various aspects, the surface-modified phosphor material can be dried at a temperature of about 40 degrees Celsius to about 120 degrees Celsius at ambient pressure. In a further aspect, the surface-modified phosphor material can be dried at a temperature of about 50 degrees Celsius to about 100 degrees Celsius at ambient pressure. In a still further aspect, the surface-modified phosphor material can be dried at a temperature of about 50 degrees Celsius to about 80 degrees Celsius at ambient pressure. In a yet further aspect, the surface-modified phosphor material can be dried at a temperature of about 60 degrees Celsius to about 80 degrees Celsius at ambient pressure. In an even further aspect, the surface-modified phosphor material can be dried at a temperature of about 65 degrees Celsius to about 75 degrees Celsius at ambient pressure.

In various aspects, the surface-modified phosphor material can be dried at a temperature of about 40 degrees Celsius to about 120 degrees Celsius in vacuo. In a further aspect, the surface-modified phosphor material can be dried at a temperature of about 50 degrees Celsius to about 100 degrees Celsius in vacuo. In a still further aspect, the surface-modified phosphor material can be dried at a temperature of about 50 degrees Celsius to about 80 degrees Celsius at ambient pressure. In a yet further aspect, the surface-modified phosphor material can be dried at a temperature of about 60 degrees Celsius to about 80 degrees Celsius in vacuo. In an even further aspect, the surface-modified phosphor material can be dried at a temperature of about 65 degrees Celsius to about 75 degrees Celsius in vacuo.

In various aspects, the phosphor material mixture comprises a phosphor material having an average particle size of about 1 nm to about 5200 nm. In a further aspect, the phosphor material mixture comprises a phosphor material having an average particle size of about 2 nm to about 110 nm. In a still further aspect, the phosphor material mixture comprises a phosphor material having an average particle size of about 2 nm to about 21 nm. In a yet further aspect, the phosphor material mixture comprises a phosphor material having an average particle size of about 2 nm to about 11 nm.

In a further aspect, the phosphor material mixture comprises a phosphor material having an average particle size of about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 39 nm, about 40 nm, about 41 nm, about 42 nm, about 43 nm, about 44 nm, about 45 nm, about 46 nm, about 47 nm, about 48 nm, about 49 nm, about 50 nm, about 51 nm, about 52 nm, about 53 nm, about 54 nm, about 55 nm, about 56 nm, about 57 nm, about 58 nm, about 59 nm, about 60 nm, about 61 nm, about 62 nm, about 63 nm, about 64 nm, about 65 nm, about 66 nm, about 67 nm, about 68 nm, about 69 nm, about 70 nm, about 71 nm, about 72 nm, about 73 nm, about 74 nm, about 75 nm, about 76 nm, about 77 nm, about 78 nm, about 79 nm, about 80 nm, about 81 nm, about 82 nm, about 83 nm, about 84 nm, about 85 nm, about 86 nm, about 87 nm, about 88 nm, about 89 nm, about 90 nm, about 91 nm, about 92 nm, about 93 nm, about 94 nm, about 95 nm, about 96 nm, about 97 nm, about 98 nm, about 99 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, about 780 nm, about 790 nm, about 800 nm, about 810 nm, about 820 nm, about 830 nm, about 840 nm, about 850 nm, about 860 nm, about 870 nm, about 880 nm, about 890 nm, about 900 nm, about 910 nm, about 920 nm, about 930 nm, about 940 nm, about 950 nm, about 960 nm, about 970 nm, about 980 nm, about 990 nm, about 1000 nm; about 1100 nm, about 1110 nm, about 1120 nm, about 1130 nm, about 1140 nm, about 1150 nm, about 1160 nm, about 1170 nm, about 1180 nm, about 1190 nm, about 1200 nm, about 1210 nm, about 1220 nm, about 1230 nm, about 1240 nm, about 1250 nm, about 1260 nm, about 1270 nm, about 1280 nm, about 1290 nm, about 1300 nm, about 1310 nm, about 1320 nm, about 1330 nm, about 1340 nm, about 1350 nm, about 1360 nm, about 1370 nm, about 1380 nm, about 1390 nm, about 1400 nm, about 1410 nm, about 1420 nm, about 1430 nm, about 1440 nm, about 1450 nm, about 1460 nm, about 1470 nm, about 1480 nm, about 1490 nm, about 1500 nm, about 1510 nm, about 1520 nm, about 1530 nm, about 1540 nm, about 1550 nm, about 1560 nm, about 1570 nm, about 1580 nm, about 1590 nm, about 1600 nm, about 1610 nm, about 1620 nm, about 1630 nm, about 1640 nm, about 1650 nm, about 1660 nm, about 1670 nm, about 1680 nm, about 1690 nm, about 1700 nm, about 1710 nm, about 1720 nm, about 1730 nm, about 1740 nm, about 1750 nm, about 1760 nm, about 1770 nm, about 1780 nm, about 1790 nm, about 1800 nm, about 1810 nm, about 1820 nm, about 1830 nm, about 1840 nm, about 1850 nm, about 1860 nm, about 1870 nm, about 1880 nm, about 1890 nm, about 1900 nm, about 1910 nm, about 1920 nm, about 1930 nm, about 1940 nm, about 1950 nm, about 1960 nm, about 1970 nm, about 1980 nm, about 1990 nm, about 2000 nm, about 2100 nm, about 2110 nm, about 2120 nm, about 2130 nm, about 2140 nm, about 2150 nm, about 2160 nm, about 2170 nm, about 2180 nm, about 2190 nm, about 2200 nm, about 2210 nm, about 2220 nm, about 2230 nm, about 2240 nm, about 2250 nm, about 2260 nm, about 2270 nm, about 2280 nm, about 2290 nm, about 2300 nm, about 2310 nm, about 2320 nm, about 2330 nm, about 2340 nm, about 2350 nm, about 2360 nm, about 2370 nm, about 2380 nm, about 2390 nm, about 2400 nm, about 2410 nm, about 2420 nm, about 2430 nm, about 2440 nm, about 2450 nm, about 2460 nm, about 2470 nm, about 2480 nm, about 2490 nm, about 2500 nm, about 2510 nm, about 2520 nm, about 2530 nm, about 2540 nm, about 2550 nm, about 2560 nm, about 2570 nm, about 2580 nm, about 2590 nm, about 2600 nm, about 2610 nm, about 2620 nm, about 2630 nm, about 2640 nm, about 2650 nm, about 2660 nm, about 2670 nm, about 2680 nm, about 2690 nm, about 2700 nm, about 2710 nm, about 2720 nm, about 2730 nm, about 2740 nm, about 2750 nm, about 2760 nm, about 2770 nm, about 2780 nm, about 2790 nm, about 2800 nm, about 2810 nm, about 2820 nm, about 2830 nm, about 2840 nm, about 2850 nm, about 2860 nm, about 2870 nm, about 2880 nm, about 2890 nm, about 2900 nm, about 2910 nm, about 2920 nm, about 2930 nm, about 2940 nm, about 2950 nm, about 2960 nm, about 2970 nm, about 2980 nm, about 2990 nm, about 3000 nm, about 3100 nm, about 3110 nm, about 3120 nm, about 3130 nm, about 3140 nm, about 3150 nm, about 3160 nm, about 3170 nm, about 3180 nm, about 3190 nm, about 3200 nm, about 3210 nm, about 3220 nm, about 3230 nm, about 3240 nm, about 3250 nm, about 3260 nm, about 3270 nm, about 3280 nm, about 3290 nm, about 3300 nm, about 3310 nm, about 3320 nm, about 3330 nm, about 3340 nm, about 3350 nm, about 3360 nm, about 3370 nm, about 3380 nm, about 3390 nm, about 3400 nm, about 3410 nm, about 3420 nm, about 3430 nm, about 3440 nm, about 3450 nm, about 3460 nm, about 3470 nm, about 3480 nm, about 3490 nm, about 3500 nm, about 3510 nm, about 3520 nm, about 3530 nm, about 3540 nm, about 3550 nm, about 3560 nm, about 3570 nm, about 3580 nm, about 3590 nm, about 3600 nm, about 3610 nm, about 3620 nm, about 3630 nm, about 3640 nm, about 3650 nm, about 3660 nm, about 3670 nm, about 3680 nm, about 3690 nm, about 3700 nm, about 3710 nm, about 3720 nm, about 3730 nm, about 3740 nm, about 3750 nm, about 3760 nm, about 3770 nm, about 3780 nm, about 3790 nm, about 3800 nm, about 3810 nm, about 3820 nm, about 3830 nm, about 3840 nm, about 3850 nm, about 3860 nm, about 3870 nm, about 3880 nm, about 3890 nm, about 3900 nm, about 3910 nm, about 3920 nm, about 3930 nm, about 3940 nm, about 3950 nm, about 3960 nm, about 3970 nm, about 3980 nm, about 3990 nm, about 4000 nm, about 4100 nm, about 4110 nm, about 4120 nm, about 4130 nm, about 4140 nm, about 4150 nm, about 4160 nm, about 4170 nm, about 4180 nm, about 4190 nm, about 4200 nm, about 4210 nm, about 4220 nm, about 4230 nm, about 4240 nm, about 4250 nm, about 4260 nm, about 4270 nm, about 4280 nm, about 4290 nm, about 4300 nm, about 4310 nm, about 4320 nm, about 4330 nm, about 4340 nm, about 4350 nm, about 4360 nm, about 4370 nm, about 4380 nm, about 4390 nm, about 4400 nm, about 4410 nm, about 4420 nm, about 4430 nm, about 4440 nm, about 4450 nm, about 4460 nm, about 4470 nm, about 4480 nm, about 4490 nm, about 4500 nm, about 4510 nm, about 4520 nm, about 4530 nm, about 4540 nm, about 4550 nm, about 4560 nm, about 4570 nm, about 4580 nm, about 4590 nm, about 4600 nm, about 4610 nm, about 4620 nm, about 4630 nm, about 4640 nm, about 4650 nm, about 4660 nm, about 4670 nm, about 4680 nm, about 4690 nm, about 4700 nm, about 4710 nm, about 4720 nm, about 4730 nm, about 4740 nm, about 4750 nm, about 4760 nm, about 4770 nm, about 4780 nm, about 4790 nm, about 4800 nm, about 4810 nm, about 4820 nm, about 4830 nm, about 4840 nm, about 4850 nm, about 4860 nm, about 4870 nm, about 4880 nm, about 4890 nm, about 4900 nm, about 4910 nm, about 4920 nm, about 4930 nm, about 4940 nm, about 4950 nm, about 4960 nm, about 4970 nm, about 4980 nm, about 4990 nm, about 5000 nm; or any range encompassed by the foregoing values; or any combination of the foregoing values.

### Phosphor Materials

In various aspects, a suitable phosphor for use in the disclosed methods is a silicate phosphor, an aluminate phosphor, a nitride phosphor, an oxynitride phosphor, a sulfide phosphor or an oxysulfide phosphor.

In various aspects, the phosphor is selected from calcium sulfide, strontium sulfide, zinc sulfide, cadmium sulfide, copper sulfide, silver sulfide, barium sulfide, or combinations thereof. In a further aspect, a phosphor comprising a sufide can be doped with at least one rare earth ion Eu, Tb, Ce, Dy, Sm, Yb and Er, Nd, Pr, Gd, Tm, or combinations thereof. In a still further aspect, a phosphor comprising a sufide can be doped with non-rare earth ion Mn, Ga, In, Al, Zn, Cu, or combinations thereof.

In a further aspect, the phosphor is a calcium sulfide phosphor doped with Eu; a calcium sulfide phosphor doped with Eu and Mn; a strontium sulfide phosphor doped with Eu; a strontium sulfide phosphor doped with Eu and Mn; a zinc sulfide phosphor doped with Eu; a zinc sulfide phosphor doped with Eu and Mn; a cadmium sulfide phosphor; a cadmium sulfide phosphore doped with Zn; a cadmium sulfide phosphor doped with Zn and Cu; or combinations thereof.

In various aspects, the phosphor is a sulfide phosphor such as, for example, (Ca, Sr, Ba)(Al, In, Ga)₂S₄:Eu, (Ca, Sr)S:Eu, CaS:Eu, (Zn, Cd)S:Eu:Ag. In other aspects, the phosphor is a nitride phosphor such as, for example, (Ca, Sr, Ba)₂Si₅N₈:Eu, CaAlSiN₃:Eu, Ce(Ca, Sr, Ba)Si₇N₁₀:Eu or (Ca, Sr, Ba)SiN₂:Eu. Other exemplary phosphors include Ba²⁺, Mg²⁺ co-doped Sr₂SiO₄, (Y, Gd, Lu, Sc, Sm, Tb, Th, Ir, Sb, Bi)₃(AI, Ga)₅O₁₂:Ce (with or without Pr), YSiO₂N:Ce, Y₂Si₃O₃N₄:Ce, Gd₂Si₃O₃N₄:Ce, (Y, Gd, Tb, Lu)₃Al₅₋ₓSiₓO₁₂₋ₓ:Ce, BaMgAl₁₀O₁₇:Eu (with or without Mn), SrAl₂O₄:Eu, Sr₄Al₄O₂₅:Eu, (Ca, Sr, Ba)Si₂N₂O₂:Eu, SrSi, Al₂O₃N₂:Eu, (Ca, Sr, Ba)Si₂N₂O₂:Eu, (Ca, Sr, Ba)SiN₂:Eu and (Ca, Sr, Ba)SiO₄:Eu. (See, for further details of these phosphors, Winkler et al., U.S. Patent Application Publ. No. 2010/0283076; Lee et al., Applied Surface Science 257, (2011) 8355-8369; both incorporated by reference herein.)

In various aspects, the phosphor is an aluminum-silicate-based orange-red phosphor with mixed divalent and trivalent cations of formula (Sr_{1-x-y}MₓT_{y})₃₋ₘEuₘ(Si₁₋ₓAl_{z})O₅ where M is at least one of Ba, Mg and Zn, T is a trivalent metal, 0≤x≤0.4, 0≤y≤0.4, 0≤z≤0.2 and 0.001≤m≤0.4. (See, for further details of these phosphors, Liu et al., U.S. Patent Application Publ. No. 2008/0111472, incorporated by reference herein.)

In various aspects, the phosphor is a YAG:Ce phosphor of formula (Y,A)₃(Al,B)₅(O,C)₁₂:Ce³⁺ where A is selected from the group consisting of Tb, Gd, Sm, La, Sr, Ba, Ca, and where A substitutes for Y in amounts ranging from about 0.1 to 100 percent; B is selected from the group consisting of Si, Ge, B, P and Ga, and where B substitutes for Al in amounts ranging from about 0.1 to 100 percent; and, C is selected from the group consisting of F, Cl, N and S and where C substitutes for 0 in amounts ranging from about 0.1 to 100 percent. (See, for further details of these phosphors, Tao et al., U.S. Patent Application Publ. No. 2008/0138268, incorporated by reference herein.)

In various aspects, the phosphor is a silicate-based yellow-green phosphor of formula A₂SiO₄:Eu²⁺D where A is Sr, Ca, Ba, Mg, Zn and Cd; and D is a dopant selected from the group consisting of F, Cl, Br, I, P, S and N. (See, for further details of these phosphors, Wang et al., U.S. Pat. No. 7,311,858, incorporated by reference herein.)

In various aspects, the phosphor is an aluminate-based blue phosphor of formula (M₁₋ₓEuₓ)_{2-z}MgAl_{y})O_{(2+3/2)y} where M is at least one of Ba and Sr, (0.05<x<0.5; 3≤y≤8; and 0.8≤z≤1<1.2) or (0.2<x<0.5; 3≤y≤8; and 0.8≤z≤1<1.2) or (0.05<x<0.5; 3≤y≤12; and 0.8≤z≤1<1.2) or (0.2<x<0.5; 3≤y≤12; and 0.8≤z≤1<1.2) or (0.05<x<0.5; 3≤y≤6; and 0.8≤z≤1.2). (See, for further details of these phosphors, Dong et al., U.S. Pat. No. 7,390,437, incorporated by reference herein.)

In various aspects, the phosphor is a yellow phosphor of formula (Gd₁₋ₓAₓ)(V_{1-y}B_{y})(O_{4-z}C_{z}) where A is Bi, Tl, Y, La, Ce, Pr, Nd, Pm, Sm, Eu, Tb, Dy, Ho, Er, Tm, Yb, Lu; B is Ta, Nb, W, and Mo; C is N, F, Br and I; 0<x<0.2; 0<y<0.1; and 0<z<0.1. (See, for further details of these phosphors, Li et al., U.S. Pat. No. 7,399,428, incorporated by reference herein.)

In various aspects, the phosphor is a yellow phosphor of formula A[Srₓ(M₁)₁₋ₓ]_{z}SiO₄·(1-a)[Sr_{y}(M₂)_{1-y}]ᵤSiO₅:EU²⁺D where M₁ and M₂ are at least one of a divalent metal such as Ba, Mg, Ca, and Zn; 0.6≤a≤0.85; 0.3≤x≤0.6; 0.8≤y≤1; 1.5≤z≤2.5; and 2.6≤u≤3.3 and Eu and D are between 0.0001 and about 0.5; D is an anion selected form the group consisting of F, Cl, Br, S and N and at least some of D replaces oxygen in the host lattice. (See, for further details of these phosphors, Li et al., U.S. Pat. No. 7,922,937 incorporated by reference herein.)

In various aspects, the phosphor is a silicate-based green phosphor of formula (Sr,A₁)ₓ(Si,A₂)(O,A₃)₂₊ₓ:Eu²⁺ where A₁ is at least one divalent metal ion such as Mg, Ca, Ba, Zn or a combination of +1 and =3 ions; A₂ is a 3+, 4+ or 5+ cation including at least one of B, Al, Ga, C, Ge, P; A₃ is a 1−, 2− or 3− anion including F, Cl, and Br; and 1.5≤x≤2.5. (See, for further details of these phosphors, Li et al., U.S. Patent Application Publ. No. 2009/0294731, incorporated by reference herein.)

In various aspects, the phosphor is a nitride-based red phosphor of formula MₐM_{b}B_{c}(N,D):Eu²⁺ where Mₐ is a divalent metal ion such as Mg, Ca, Sr, Ba; M_{b} is trivalent metal such as Al, Ga, Bi, Y, La, Sm; M_{c} is a tetravalent element such as Si, Ge, P1, and B; N is nitrogen; and D is a halogen such as F, Cl, or Br. (See, for further details of these phosphors, Liu et al., U.S. Patent Application Publ. No. 2009/0283721, incorporated by reference herein.)

In various aspects, the phosphor is a silicate-based orange phosphor of formula (Sr,A₁)ₓ(Si,A₂)(O,A₃)₂₊ₓ:Eu²⁺ where A₁ is at least one divalent metal ion such as Mg, Ca, Ba, Zn or a combination of +1 and =3 ions; A₂ is a 3+, 4+ or 5+ cation including at least one of B, Al, Ga, C, Ge, P; A₃ is a 1−, 2− or 3− anion including F, Cl, and Br; and 1.5≤x≤2.5. (See, for further details of these phosphors, Cheng et al., U.S. Pat. No. 7,655,156, incorporated by reference herein.)

In various aspects, the phosphor is a aluminate-based green phosphor of formula M₁₋ₓEuₓMg_{1-y}Mn_{y}Al_{z}O_{[(x+y)+3z/2)} where 0.1<x<1.0; 0.1<y<1.0; 0.2<x+y<2.0; and 2≤z≤14. (See, for further details of these phosphors, Wang et al., U.S. Pat. No. 7,755,276, incorporated by reference herein.)

In various aspects, the phosphors include a rare earth halide as a raw material source of not only the rare earth activator for the phosphor but also the halogen itself. While not wishing to be bound by any particular theory or mechanism of action, it is believed that the halogen may play a dual role in enhancing the properties of these phosphors by (i) reducing the oxygen content and (ii) causing an increase in photoluminescent intensity and spectral emission. The silicon dioxide coating provides an increase in the reliability of the phosphors.

### Silane Materials

In various aspects, a suitable silane coupling agent for use in the disclosed methods is a saturated linear branched or unbranched compound having the nonhydrolyzed formula RₙSiM₄₋ₙ, wherein n is preferably greater than 1. Preferably, M is selected from the group consisting of a halogen, an optionally substituted alkoxy group, an an optionally substituted acyloxy group, or an optionally substituted amine group. R is preferably an optionally substituted hydrocarbon group that is classified as an aliphatic group, cyclic group, or a combination of aliphatic and cyclic groups (e.g., alkaryl and aralkyl groups).

In a further aspect, the silane coupling agent used in the disclosed methods has a structure represented by a formula:

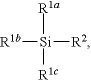

wherein each of R^{1a}, R^{1b}, and R^{1c} are independently selected from hydrogen, halogen, hydroxyl, C1-C12 alkyl, C1-C12 alkoxy, phenyl, and —O-phenyl; and wherein R² is selected from substituted C1-C60 alkyl, substituted C1-C60 alkylamine, substituted C1-C60 alkenyl, substituted C3-C60 cycloalkyl, substituted C3-C60 cycloalkenyl, and substituted C3-C60 aryl.

Suitable silane coupling agents for use in the disclosed methods include, for example, 1,3-divinyltetramethyldisiloxane, 1,3-diphenyltetramethyldisiloxane, 3-aminopropyltrimethoxysilane, 3-aminopropylmethyldiethoxysilane, i-butyltriethoxysilane, i-buthyltrimethoxysilane, i-propyltriethoxysilane, i-propyltrimethoxysilane, N-beta (aminoethyl) γ-aminopropyltrimethoxysilane, N-beta (aminoethyl) γ-aminopropylmethyldimethoxysilane, n-octadecyltrimethoxysilane, N-phenyl-γ-aminopropyltrimethoxysilane, n-buthyltrimethoxysilane, n-propyltriethoxysilane, n-propyltrimethoxysilane, n-hexadecyltrimethoxysilane, o-methylphenyltrimethoxysilane, p-methylphenyltrimethoxysilane, tert-butyldimethylchlorosilane, a-chloroethyltrichlorosilane, beta-(3,4-epoxycyclohexyl) ethyltrimethoxysilane, beta-(3,4-epoxycyclohexyl) ethyltrimethoxysilane, beta-chloroethyltrichlorosilane, beta-(2-aminoethyl) aminopropyltrimethoxysilane, γ-(2-aminoethyl) aminopropylmethyldimethoxysilane, γ-anilinopropyltrimethoxysilane,γ-aminopropyltriethoxysilane, γ-aminopropyltrimethoxysilane, γ-glycidoxypropyltrimethoxysilane, γ-glycidoxypropylmethyldiethoxysilane, γ-glycidoxypropylmethyldimethoxysilane, γ-chloropropyltrimethoxysilane, γ-chloropropylmethyldimethoxysilane, γ-methacryloxypropyltrimethoxysilane, γ-mercaptopropyltrimethoxysilane, aminopropyltriethoxysilane, aminopropyltrimethoxysilane, allyldimethylchlorosilane, allyltriethoxysilane, allylphenyldichlorosilane, isobutyltrimethoxysilane, ethyltriethoxysilane, ethyltrichlorosilane, ethyltrimethoxysilane, octadecyltriethoxysilane, octadecyltrimethoxysilane, octyltrimethoxysilane, chloromethyldimethylchlorosilane, diethylaminopropyltrimethoxysilane, diethyldiethoxysilane, diethyldimethoxysilane, dioctyl aminopropyltrimethoxysilane, diphenyldiethoxysilane, diphenyldichlorosilane, diphenyldimethoxysilane, dibuthylaminopropyldimethoxysilane, dibuthylaminopropyltrimethoxysilane, dibuthylaminopropylmonomethoxysilane, dipropylaminopropyltrimethoxysilane, dihexyldiethoxysilane, dihexyldimethoxysilane, dimethylaminophenyltriethoxysilane, dimethylethoxysilane, dimethyldiethoxysilane, dimethyldichlorosilane, dimethyldimethoxysilane, decyltriethoxysilane, decyltrimethoxysilane, dodecyltrimethoxysilane, triethylethoxysilane, triethylchlorosilane, triethylmethoxysilane, triorganosilyl acrylate, tripropylethoxysilane, tripropylchlorosilane, tripropylmethoxysilane, trihexylethoxysilane, trihexylchlorosilane, trimethylethoxysilane, trimethylchlorosilane, trimethylsilane, trimethylsilylmercaptan, trimethylmethoxysilane, trimethoxysilyl-γ-propylphenylamine, trimethoxysilyl-γ-propylbenzylamine, naphthyltriethoxysilane, naphthyltrimethoxysilane, nonyltriethoxysilane, hydroxypropyltrimethoxysilane, vinyldimethylacetoxysilane, vinyltriacetoxysilane, vinyltriethoxysilane, vinyltrichlorosilane, vinyltris (beta-methoxyethoxy) silane, vinyltrimethoxysilane, phenyltriethoxysilane, phenyltrichlorosilane, phenyltrimethoxysilane, butyltriethoxysilane, butyltrimethoxysilane, propyltriethoxysilane, propyltrimethoxysilane, bromomethyldimethylchlorosilane, hexamethyldisiloxane, hexyltrimethoxysilane, benzyldimethylchlorosilane, pentyltrimethoxysilane, methacryloxyethyldimethyl (3-trimethoxysilylpropyl) ammonium chloride, methyltriethoxysilane, methyltrichlorosilane, methyltrimethoxysilane, methylphenyldimethoxysilane and monobutylaminopropyltrimethoxysilane.

Other suitable silane coupling agents including, but are not limited to, vinyl triethoxysilane, vinyl-tris-(beta-methoxyethoxy)silane, methacryloylpropyltrimethoxysilane, gamma-amino-propyl triethoxysilane (sold commercially as “A 1100” by Witco), gamma-mercaptopropyltrimethoxysilane bis(2-triethoxysilyl-ethyl) tetrasulfide, bis(3-trimethoxysilyl-propyl) tetrasulfide, bis(2-trimethoxysilyl-ethyl) tetrasulfide, 3-mercaptopropyl-triethoxy silane, 2-mercaptopropyl-trimethoxy silane, 2-mercaptopropyl-triethoxy silane, 3-nitropropyl-trimethoxysilane, 3-nitropropyl-triethoxysilane, 3-chloropropyl-trimethoxysilane, 3-chloropropyl-triethoxysilane, 2-chloropropyl-trimethoxysilane, 2-chloropropyl-triethoxysilane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropyl-benzothiazole tetrasulfide, 3-trimethoxysilylpropyl-methacrylate monosulfide, 3-trimethoxysilylpropyl-methacrylate monosulfide, and the like, and mixtures thereof. Suitable silane coupling agents are further described in U.S. Pat. Nos. 5,827,912, 5,780,535, 6,005,027, 6,136,913, and 6,121,347. In one aspect, the silane is selected from the group consisting of bis-(3(triethoxysilyl)-propyl)-tetrasulfane (sold commercially as “Si 69” by Degussa), 3-thiocyanatopropyl-triethoxy silane (“Si 264”), and is 3-mercaptopropyl-trimethoxy silane (“Si 189”).

In various aspects, an organofunctional silane for use as a silane coupling agent in the disclosed methods comprises gamma-methacryloxypropyltrimethoxysilane. This material is available from Union Carbide Corporation under their designation A−174, from Dow Corning Corporation under their designation Z6030, from Petrarch Systems Silanes & Silicones, Bristol, Pa., under their designation M8550, or from PCR Research Chemicals, Inc., under their designation 29670-7. Many other silane coupling agents are commercially available, some of which have organic groups having various degrees of reactivity and others of which are not reactive, insofar as reaction with a specific organic resin is concerned. Additional exemplary silane materials from the many available include 3-(2-Aminoethylamino)propyltrimethoxysilane, 3-Chloropropyltrichlorosilane, 3-chloropropyltrimethoxysilane, dimethyldichlorosilane, ethyltrichlorosilane, methyltrichlorosilane, methyltrimethoxysilane, phenylmethyldichlorosilane, phenyltrichlorosilane, trimethylchlorosilane, vinyltriacetoxysilane, (2-methoxyethoxy)silane, vinyl-tris(2-methoxyethoxy)silane, beta-3, (4-epoxycyclohexyl)ethyltrimethoxysilane, gamma-mercaptopropyltrimethoxysilane, gamma-aminopropyltriethoxysilane, or combinations thereof.

In various aspects, a suitable silane coupling agent is an acrylic silane such as 3-(methacryloyloxy)propyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, 3-(Acryloxypropyl)trimethoxysilane, Vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, and any combination thereof.

In various aspects, a suitable silane coupling agent can be represented by the formula A-B, where the A-moiety is capable of attaching to the surface of a particle and the B-moiety is comprises alkyl, aryl, or other surface modifying chemical moieties.

Suitable classes of surface modifying agents include, e.g., silanes, organic acids, organic bases, thiols and alcohols. For example, alkoxysilanes having the general structure (R¹)₄₋ₙ—Si—(OR²)ₙ, where n=1, 2, or 3, and chlorosilanes having the general structure (R¹)₄₋ₙ—Si—Clₙ, where n=1, 2, or 3, can be regarded as surface modifying or coupling agents represented by the formula A-B, where the Si—(OR²)ₙ or Si—Clₙ reacts with the surface of the silica particle, and the R¹ modifies the nature of the surface. Non-limiting examples of useful A-B type silanes include organosilanes such as alkylchlorosilanes, alkoxysilanes, methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-prop yltriethoxysilane, butyltri methoxysilane, butyltriethoxysilane, hexyltrimethoxysilane, octyltrimethoxysilane, 3-mercaptopropyltrimethoxysilane, n-octyltriethoxysilane, phenyltriethoxysilane, polytriethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri(t-butoxy)silane, vinyltris(isobutoxy)silane, vinyltris(isopropenoxy)silane and vinyltris(2-methoxyethoxy)silane; trialkoxyarylsilanes; isooctyltrimethoxy-silane; N-(3-triethoxysilylpropyl)methoxyethoxyethoxy ethyl carbamate; N-(3-triethoxysilylpropyl)methoxyethoxyethoxyethyl carbamate; silane functional (meth)acrylates such as 3-(methacryloyloxy)propyltrimethoxysilane, 3-acryloyloxypropyltrimethoxysilane, 3-(methacryloyloxy)propyltriethoxysilane, 3-(methacryloyloxy)propylmethyldimethoxy silane, 3-(acryloyloxypropyl)methyldimethoxysilane, 3-(methacryloyloxy)propyldimethylethoxysilane, 3-(methacryloyloxy)methyltriethoxysilane, 3-(methacryloyloxy)methyltrimethoxysilane, 3-(methacryloyloxy)propyldimethyl ethoxysilane, 3-(methacryloyloxy)propenyltrimethoxysilane, 3-(methacryloyloxy)propyltrimethoxysilane; polydialkylsiloxanes such as polydimethylsiloxane; arylsilanes such as substituted and unsubstituted arylsilanes; alkylsilanes such as substituted and unsubstituted alkyl silanes, methoxy and hydroxy substituted alkyl silanes, and combinations thereof.

In a further aspect, suitable silane (meth)acrylates are described, for example, in U.S. Pat. Nos. 4,491,508, 4,455,205, 4,478,876, 4,486,504 and 5,258,225, which are incorporated herein. Useful organic acid surface-modifying agents include, without limitation, oxyacids of carbon (e.g., carboxylic acid), sulfur and phosphorus, and combinations thereof.

In a further aspect, a B-moiety which can be used in the disclosed methods may be monomers having a vinyl ester moiety, including the alkyl acrylates such as methyl acrylate, the alkyl maleates such as methyl maleate, the alkyl fumarates such as ethyl fumarate, the vinyl ethers such as methyl vinyl ether, the alkyl methacrylates such as ethyl methacrylate and the alkyl itaconates such as ethyl itaconate.

In a further aspect, a B-moiety can comprise a vinyl group (e.g., ethylene, propylene, vinyl chloride, vinyl acetate, acrylates, methacrylates, styrenes, dienes) or a vinylidene group having the structural formula CH₂=C< where at least one of the disconnected valences is attached to an electronegative radical such as phenyl, acetoxy, carboxy, carbonitrile and halogen, examples of the monomers being those hereinbefore listed as well as styrene, vinylnaphthalene, alphamethylstyrene, dichlorostyrenes, alpha-methylene carboxylic acids, their esters, nitriles and amides including acrylic acid, acrylonitrile, acrylamide; the vinyl esters of alkanoic acids including vinyl formate, vinyl acetate, vinyl propionate, vinyl butyrate, vinyl pyridine; the alkyl vinyl ketones including methyl vinyl ketone; the conjugated diolefines including butadiene-1,3; isoprenes chloroprene, piperylene and 2,3-dimethyl-butadiene-1,3.

### Disclosed Articles

The present disclosure relates to a solution to the problem of aggregation of sulfide phosphors when embedded in to the polymer matrix. The polymer matrix which may be organic or inorganic may include a polymer selected from a group of thermoplastics. Examples may include and are not limited to the following materials such as polyethylene, polypropylene, polymethyl methacrylate, polystyrene and polycarbonate.

In various aspects, the disclosed surface-modified phosphor can be embedded into the polymer matrix, for example, by mixing with a polymer and then extruding, film casting, solving casting, or bulk polymerization, to yield a luminescent phosphor embedded polymer article. The luminescent phosphor embedded polymer articles may be used for converting a wavelength of radiation from a source such as solar spectrum or xenon lamp or grow light to a specific wavelength (light conversion). For example, a suitable resin, e.g., polyethylene, polymethyl methacrylate, polycarbonate, and combinations thereof, is prepared as liquid, e.g., if not a liquid at the temperature of preparation, it can be melted or solubilized in a suitable solvent, is combined with a disclosed surface-modified phosphor, and then mixed using ultrasonication, mechanical mixing, or combinations thereof. The mixture of phosphor in resin can be glass cast and cured at room temperature in vacuo.

In various aspects, the polymer matrix be derived from any suitable polymer, mixture of polymers, or polymer blend for preparing a transparent or translucent sheet, film, panel, component, or structure. In some aspects, the polymer matrix is a thermoplastic polymer. In a further aspect, the matrix material comprises a polyurethane, a polyether, a polyethylene terephthalate (PET), a polyethylene naphthalate (PEN), a cycloolefin polymer, a polyimide (PI), a polyethersulfone (PES), a polyethylene, a polyacrylate, a polycarbonate, a polystyrene, or combinations thereof. In a still further aspect, the polyacrylate can comprise poly(methyl methacrylate. In a further aspect, the polymer matrix is selected form polyethylene, polypropylene, polymethyl methacrylate, polystyrene, polycarbonate, and combinations thereof. In a still further aspect, the polymer matrix is selected form polyethylene, polymethyl methacrylate, polycarbonate, and combinations thereof.

In a further aspect, a polymer matrix-phosphor composition comprises a polymer matrix and a disclosed surface-modified phosphor, wherein the polymer matrix is present in an amount of about 50 wt % to about 99.9 wt %; wherein the disclosed surface-modified phosphor is present in an amount of about 0.1 wt % to about 50 wt %; and wherein the weight percent is based on the weight of the polymer matrix and the surface-modified phosphor. In a further aspect, a polymer matrix-phosphor composition comprises a polymer matrix and a disclosed surface-modified phosphor, wherein the polymer matrix is present in an amount of about 90 wt % to about 99.9 wt %; wherein the disclosed surface-modified phosphor is present in an amount of about 0.1 wt % to about 10 wt %; and wherein the weight percent is based on the weight of the polymer matrix and the surface-modified phosphor. In a still further aspect, a polymer matrix-phosphor composition comprises a polymer matrix and a disclosed surface-modified phosphor, wherein the polymer matrix is present in an amount of about 95 wt % to about 99.5 wt %; wherein the disclosed surface-modified phosphor is present in an amount of about 0.5 wt % to about 5 wt %; and wherein the weight percent is based on the weight of the polymer matrix and the surface-modified phosphor. In a yet further aspect, a polymer matrix-phosphor composition comprises a polymer matrix and a disclosed surface-modified phosphor, wherein the polymer matrix is present in an amount of about 92.5 wt % to about 99. 5 wt %; wherein the disclosed surface-modified phosphor is present in an amount of about 0.5 wt % to about 7.5 wt %; and wherein the weight percent is based on the weight of the polymer matrix and the surface-modified phosphor.

In a further aspect, a polymer matrix-phosphor composition comprises a polymer matrix and a disclosed surface-modified phosphor, wherein the disclosed surface-modified phosphor is present in a wt % amount based on the weight of the polymer matrix and the surface-modified phosphor of about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6.0 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7.0 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8.0 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9.0 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %; or any range encompassed by the foregoing values; or any combination of the foregoing values.

In various aspects, a disclosed polymer matrix-phosphor composition can be used to form a film having a thickness of about 1 mil to about 20 mil. In a further aspect, a disclosed polymer matrix-phosphor composition can be used to form a film having a thickness of about 5 mil to about 15 mil. In a yet further aspect, a disclosed polymer matrix-phosphor composition can be used to form a film having a thickness of about 10 mil to about 15 mil.

In various aspects, a disclosed polymer matrix-phosphor composition comprising polyethylene, polymethyl methacrylate, polycarbonate, and combinations thereof, and a disclosed surface-modified phosphor can be used to form a film having a thickness of about 1 mil to about 20 mil. In a further aspect, a disclosed polymer matrix-phosphor composition comprising polyethylene, polymethyl methacrylate, polycarbonate, and combinations thereof, and a disclosed surface-modified phosphor can be used to form a film having a thickness of about 5 mil to about 15 mil. In a yet further aspect, a disclosed polymer matrix-phosphor composition comprising polyethylene, polymethyl methacrylate, polycarbonate, and combinations thereof, and a disclosed surface-modified phosphor can be used to form a film having a thickness of about 10 mil to about 15 mil.

In some instances, a disclosed article comprises a first film comprising a foregoing film laminated to a second film without a disclosed surface-modified phosphor. In other instances, a disclosed article comprises a plurality of films laminated to one another, wherein each layer of the laminated film is selected form a foregoing film comprising a disclosed surface-modified phosphor, a film comprising a disclosed polymer matrix without a disclosed surface-modified phosphor, and combinations thereof.

In various aspects, the disclosed polymer matrix-phosphor composition prepared by the disclosed methods can be used to prepare an article, such as a film, a sheet, or a panel that is used in greenhouse glazing. In some instances, the article is a polyethylene film comprising a disclosed composition prepared by the disclosed methods. The film can be stapled, nailed, taped, tied, and attached by other locking systems to frames ranging from wood to steel and aluminum. Because polyethylene film is relatively inexpensive, its use has become widespread to the point of overwhelming dominance, particularly in commercial greenhouses where appearance is not a major concern.

In some instances, the disclosed article comprises a panel, e.g., a glass panel or panel comprising a polymer matrix such as polycarbonate, that can be used in the fabrication of greenhouse glazing, wherein a disclosed polymer matrix-phosphor composition is cast or formed in situ directly on at least one surface of the panel.

In a further aspect, the greenhouse glazing can comprise a single-thickness aliphatic polyurethane film comprising a disclosed composition prepared by the disclosed methods that is heat-bonded to a nylon body. In another aspect, the structure is a commercial greenhouse having walls formed of tubes of aliphatic polyurethane film. The tubes are stretched to form an approximately one-inch insulative air space between the sides of the tubes. In yet another aspect, the structure is a residential lean-to greenhouse. In yet another aspect, advantage is taken of the surprisingly low gas permeability of the aliphatic thermoplastic polyurethanes, particularly the polyesters, and the structure is formed with both glazing and permanently inflated air tubes of the material. Air tubes having a diameter of from one to three inches have been found to provide adequate support, and also provide ideal spacing of double layer glazing.

Numerous variations in the glazing system of the present disclosure, within the scope of the appended claims, will occur to those skilled in the art in light of the foregoing disclosure. For example, the thickness of the film comprising a disclosed composition prepared by the disclosed methods may be varied considerably. Not only polyester thermoplastic aliphatic polyurethanes may be used, but also polyether thermoplastic aliphatic polyurethanes and coextrusions of the two. For some applications, the polyurethane may be alloyed with other polymers to provide advantages of both; for example, a harder material may be provided by alloying with a polymethyl methacrylate (acrylic),

### Disclosed Greenhouse Systems

In a further aspect, disclosed herein are greenhouse systems comprising an article comprising a disclosed composition prepared by the disclosed methods. In some aspects, the A greenhouse system, comprises a greenhouse glazing wherein at least part of the greenhouse glazing comprises an article, such as a sheet, a film, or a panel, comprising a disclosed composition prepared by the disclosed methods. In various aspects, the disclosed greenhouse system can further comprise at least one plant culture.

As used herein, the term “greenhouse system” includes all types of translucent constructions such as, for example, greenhouses, glasshouses, hothouses, film tunnels or combinations thereof, that permit the protected cultivation of plants preferably comprising at least one plant culture. In this context, the greenhouse system can comprise at least one, but also a plurality of various translucent constructions that are connected to each other in some manner, for example, by passages, corridors, tunnels, doors, gates or locks. The individual translucent constructions that permit the protected cultivation of plants can be in the form of, for example, individual structures (each with four exposed walls), serial structures (with at least one shared partition between two adjacent constructions) or block structures (as contiguous blocks with exterior walls, but without partitions between adjacent constructions).

A plant culture as set forth in accordance with an exemplary aspect of the present disclosure encompasses at least one plant, but preferably two or more preferably adjacent plants, that are being cultivated. In this context, a plant culture can also comprise different or especially preferably identical plants.

Moreover, the greenhouse system can also comprise several identical or especially preferably, different plant cultures.

A part of the glazing of the greenhouse system as set forth herein refers to at least one section of the glazing of the greenhouse system, that is to say, for example, at least one glass sheet used for the glazing. Thus, terms like “a part of the glazing” as set forth herein especially preferably refer to the roof glazing of the greenhouse system or to a part thereof.

A part of the glazing of the greenhouse system as set forth herein can amount to preferably at least 5%, preferably at least 10%, also preferably at least 15%, also preferably at least 20%, also preferably at least 25%, also preferably at least 30%, also preferably at least 35%, also preferably at least 40%, also preferably at least 45%, especially preferably at least 50% of the glazing and especially of the roof glazing of the greenhouse system.

A part of the glazing of the greenhouse system as set forth herein can amount to up to 55%, preferably up to 60%, also preferably up to 65%, also preferably up to 70%, also preferably up to 75%, also preferably up to 80%, also preferably up to 85%, also preferably up to 90%, also preferably up to 95%, especially preferably up to 100% of the glazing and especially of the roof glazing of the greenhouse system.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Synthesis of a Disclosed Nanophosphor (CaS:Eu). Europium doped calcium sulfide (CaS:Eu) nanophosphor was synthesized using solid state chemistry. Briefly, 2 mol % europium doped CaS nanophosphor was prepared as follows: (a) 0.98 mmol calcium nitrate tetrahydrate, 0.02 mmol europium chloride hexahydrate and 1 mmol sulfur powder were hand ground and mixed using a mortar and pestle; (b) once the reactants were well mixed, the mixture was transferred to a crucible and heated at 700° C. for 6 hours under reducing atmosphere; (c) heat is removed and the crucible was allowed to cool to room temperature; and (d) powder was removed and ground with a mortar and pestle, transferred to a vial and stored at room temperature under dry conditions. The presence of a reducing atmosphere in step (b) is important in order to reduce Eu³⁺ to Eu²⁺.

Preparation of a Disclosed Coated Nanophosphor (CaS:Eu). 100 mg of CaS:Eu phosphor, prepared as described above, was dispersed in 10 mL ethanol using ultrasonication to prepare a CaS:Eu phosphor/ethanol mixture. In another beaker, 200 μL of 3-methacryloxypropyltrimethoxysilane was mixed with 900 μl ethanol and 100 μl deionized water and was stirred at room temperature for 15 minutes. After stirring, the pH of the solution was adjusted to about 3.5 using diluted HCl. After adjusting the pH, the solution was stirred using a magnetic stirrer for 1 hour, and then added to a three neck flask containing the CaS:Eu phosphor/ethanol mixture (10 mL). The mixture was stirred using a magnetic stirrer for an additional 1 hour, and then heated at 65° C. under an inert atmosphere for 2 hours. After heating for 2 hours the heating was stopped, and the reaction mixture was allowed to cool to room temperature. Finally, the coated CaS:Eu phosphor was separated from the reaction mixture using centrifugation. The powder form of the coated CaS:Eu phosphor was obtained by drying (at 40° C.) the material collected from centrifugation.

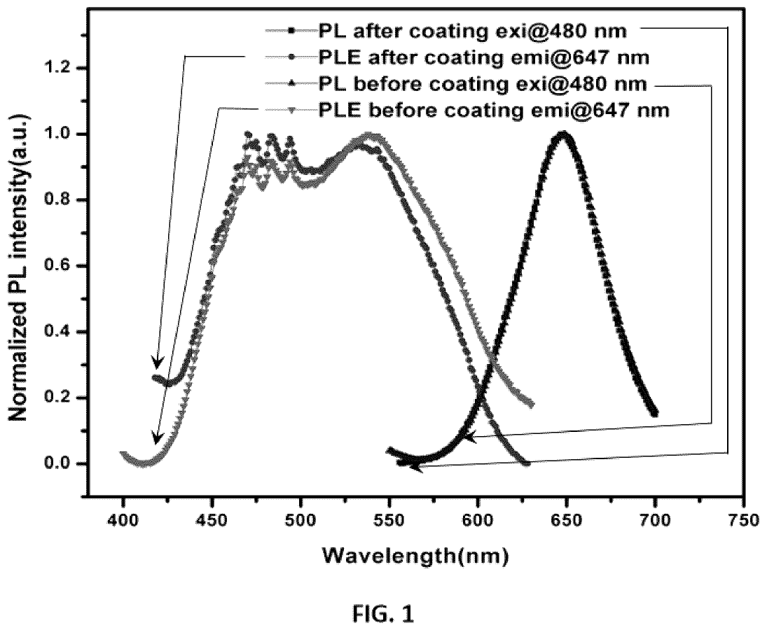

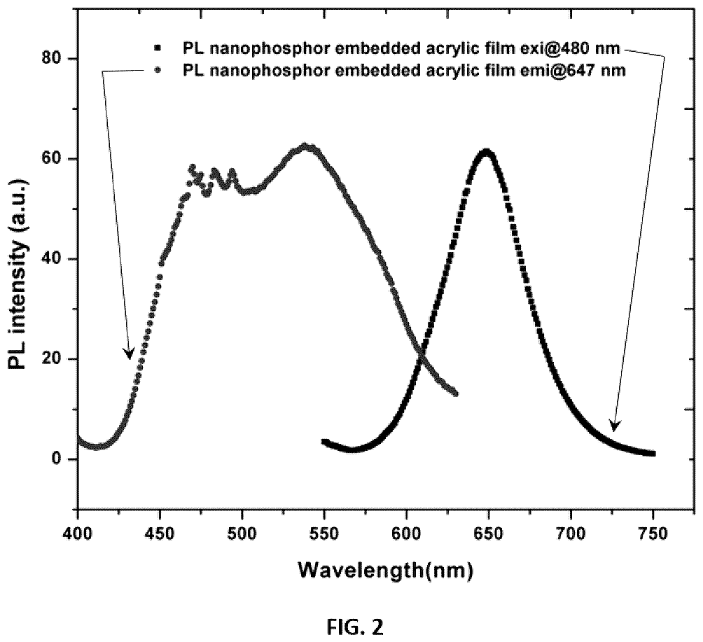

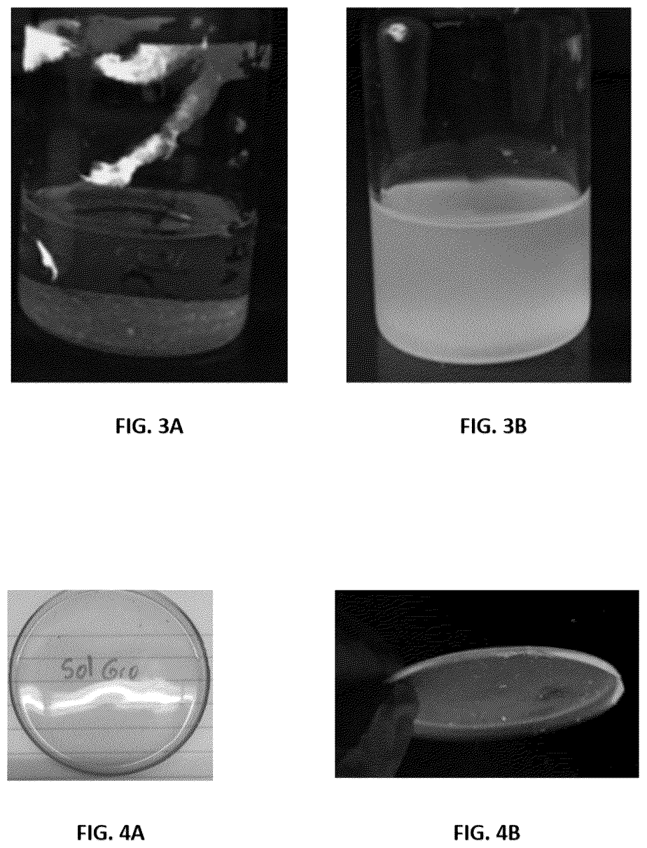

Preparation and Testing of a Disclosed Article. The coated nanophosphor (CaS:Eu), prepared as described above, was added to a polymer blend comprising acrylic and polystyrene resins at a level of 0.1 wt % of the coated nanophosphor (CaS:Eu) based on the total weight of the resin blend and the coated nanophosphor (CaS:Eu). The coated nanophosphor (CaS:Eu) was dispersed in the resin blend by mechanical stirring. A control composition comprising the same acrylic/polystyrene resin blend was prepared using an uncoated coated nanophosphor (CaS:Eu) material, i.e., the nanophosphor (CaS:Eu) prepared as described above, but not treated with the 3-methacryloxypropyltrimethoxysilane. Polymer test films were obtained by casting the resin into a glass container and drying under vacuum at room temperature. The data in FIG. 1 shows that a nanophosphor (CaS:Eu) coated with 3-methacryloxypropyltrimethoxysilane has similar excitation or emission characteristics compared to an uncoated control nanophosphor (CaS:Eu). Moreover, as shown in FIG. 2, the desired photoluminescence of the coated nanophosphor (CaS:Eu) was maintained once dispersed in disclosed article, i.e., dispersed nanophosphor (CaS:Eu) in a solid acrylic/polystyrene film. The images shown in FIGS. 3A-3B show that uncoated nanophosphor (CaS:Eu) is poorly dispersed in an acrylic/polystyrene blend and tends to clump (see FIG. 3A), whereas the coated nanophosphor (CaS:Eu) shows essentially homogeneous dispersion throughout the acrylic/polystyrene blend (see FIG. 3B). The images shown in FIGS. 4A-4B provide further confirmation that a disclosed coated nanophosphor (CaS:Eu) retains the desired photoluminescence properties of the phosphor. That is, under ambient room light, the coated nanophosphor (CaS:Eu) was not photoluminescent (see FIG. 4A), whereas under UV light, the solid acrylic/polystyrene film shows evenly distributed photoluminescence (see FIG. 4A).

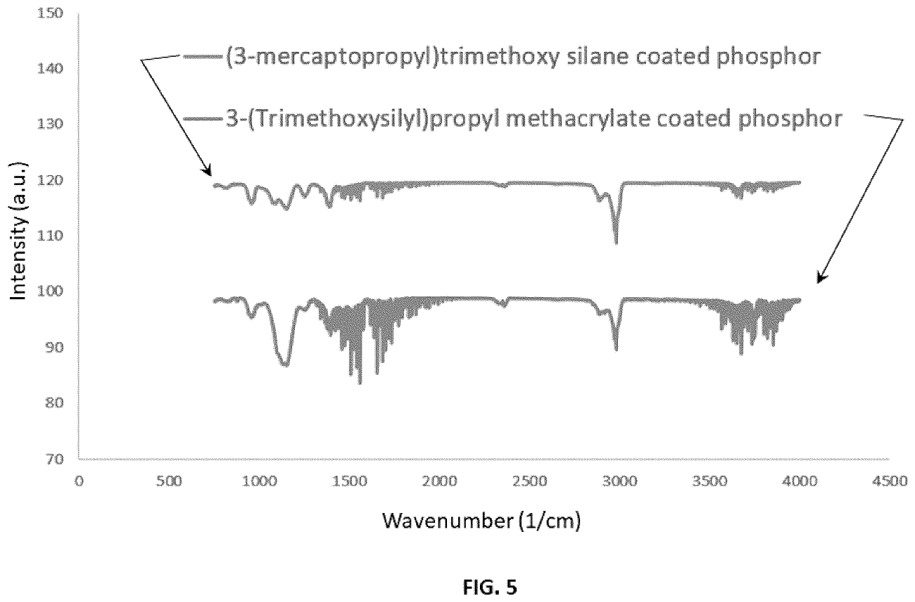

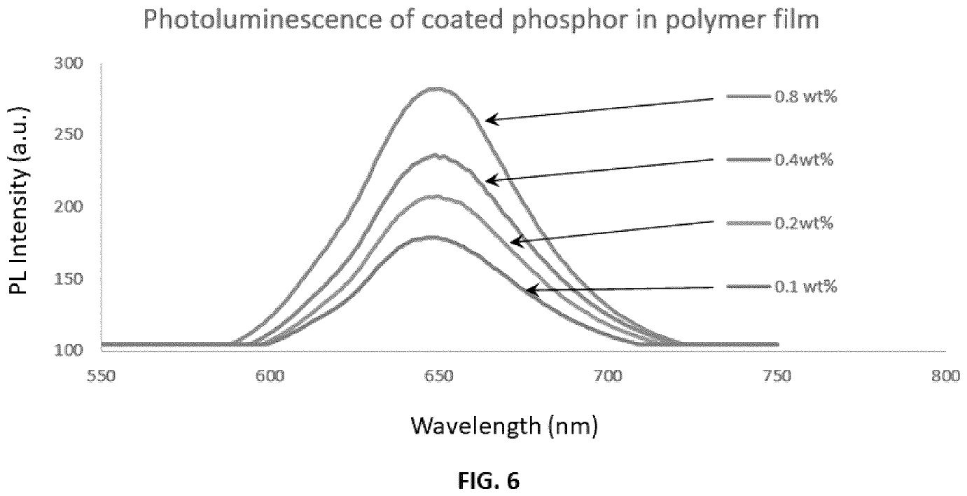

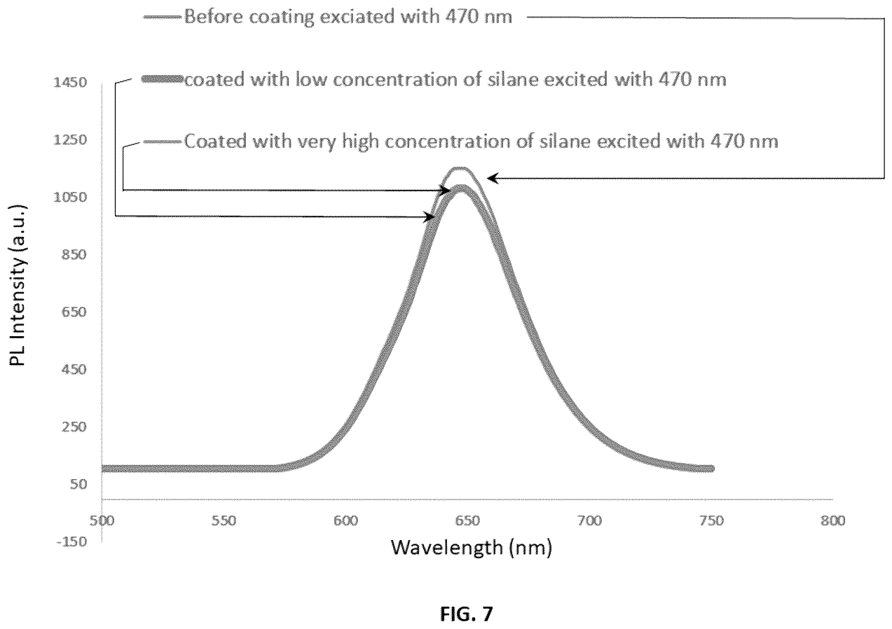

Preparation of a Disclosed Coated Nanophosphor (CaS:Eu). 80 mg europium doped calcium sulfide phosphor was dispersed in 16.5 ml ethanol using ultrasonication for 1 hour. In another beaker 300 microliter of (3-mercaptopropyl)trimethoxysilane or (3-trimethoxysilyl)propyl methacrylate was added to 3 ml water and 0.5 ml ethanol, and the pH of this solution was adjusted change to pH 3.5 using HCl, then stirred at room temperature for 1 hr. After 1 hr, the silane solution was added to phosphor in ethanol solution. The reaction was carried out with stirring at room temperature for about 4 hr. After completion, coated nanophosphor particles were separated by centrifugation, washed with ethanol twice, and dried under a vacuum at 70 degrees Celsius. FIG. 5 shows a FTIR spectra of a phosphor powder coated with different silane. The Si-o-Si band between 1000-1300 cm⁻¹ in the FTIR spectra shows silane bonding on phosphor for coated nanophosphors prepared using either 3-(mercaptopropyl)trimethoxy silane or 3-(Trimethoxysilyl)propyl methacrylate. FIG. 6 shows emission spectra of polymer film loaded with a silane coated phosphor, i.e., the foregoing europium doped calcium sulfide phosphor coated with 3-(trimethoxysilyl)propyl methacrylate, dispersed in a polymethyl methacarylate polymer as described above. The film formed had a 2 mm thickness. Emission spectra were obtained following excitation at 470 nm. FIG. 7 shows photoluminescence emission of the coated phosphor before and after coating with low and high concentration of silane. In the data shown in FIG. 7, the coated phosphor was prepared as described herein above, and the low concentration sample was prepared using 3-(trimethoxysilyl)propyl methacrylate at 0.005 v/v and the high concentration sample was prepared using 3-(trimethoxysilyl)propyl methacrylate at 0.05 v/v. The spectra were obtained from coated nanophosphor samples.

It should be emphasized that the above-described aspects of the present disclosure are merely possible examples of implementations set forth for a clear understanding of the principles of the disclosure. Many variations and modifications may be made to the above-described aspect(s) without departing substantially from the spirit and principles of the disclosure. All such modifications and variations are intended to be included herein within the scope of this disclosure and protected by the following claims.

1. A greenhouse system, wherein at least one component of the greenhouse system comprises 0.01 wt % to 10 wt % of a surface-modified phosphor material and 99.99 wt % to 90 wt % of a matrix material, based on the total weight of the surface-modified phosphor material and the matrix material.

2. The greenhouse system of claim 1, wherein the component comprises a sheet, a film, glazing, or panel, and the surface-modified phosphor material is dispersed throughout the matrix material.

3. The greenhouse system of claim 1, wherein the matrix material comprises a polyethylene, a polyacrylate, a polycarbonate, a polystyrene, or combinations thereof.

4. The greenhouse system of claim 1, wherein the matrix material comprises a polyethylene.

5. The greenhouse system of claim 1, wherein the phosphor material has a particle size of 1 nm to 1000 nm.

6. The greenhouse system of claim 1, wherein the phosphor material has a particle size of 5 nm to 300 nm.

7. The greenhouse system of claim 1, wherein the phosphor material comprises a sulfide phosphor, wherein the sulfide phosphor comprises sulfur and a metal selected from calcium, strontium, cadmium, zinc, and combinations thereof.

8. The greenhouse system of claim 6, wherein the sulfide phosphor further comprises a rare earth element selected from Eu, Tb, Ce, Dy, Sm, Yb, Er, and combinations thereof.

9. The greenhouse system of claim 1, wherein the sulfide phosphor is (Ca, Sr, Ba)(Al, In, Ga)₂S₄:Eu, (Ca, Sr)S:Eu, CaS:Eu, (Zn, Cd)S:Eu:Ag, or combinations thereof.

10. The greenhouse system of claim 1, wherein the surface-modified phosphor material is produced by the method comprising:
preparing a phosphor material mixture consisting of a phosphor material and a liquid comprising a first alcohol, wherein the phosphor material is a sulfide phosphor;
preparing a surface-modifying solution comprising a silane, water, and a second alcohol, wherein the surface-modifying solution has a pH of from 2 to 6;
preparing a surface-modifying phosphor reaction mixture by mixing the phosphor material mixture and the surface-modifying solution, wherein the surface-modifying phosphor reaction mixture has a weight ratio of the silane to the phosphor material of 0.7:1 to 5:1; and
heating the surface-modifying phosphor reaction mixture in an inert atmosphere at a temperature of from 40° C. to 100° C. for a period of 15 minutes to 6 hours;
thereby forming the surface-modified phosphor material.

11. The greenhouse system of claim 10, wherein the first alcohol is methanol, ethanol, propanol, butanol, or mixtures thereof.

12. The greenhouse system of claim 10, wherein the silane has a structure represented by a formula: 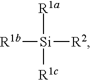
wherein each of R^{1a}, R^{1b}, and R^{1c} are independently selected from hydrogen, halogen, hydroxyl, C1-C12 alkyl, C1-C12 alkoxy, phenyl, —O-phenyl; and
wherein R² is selected from substituted C1-C60 alkyl, substituted C1-C60 alkylamine, substituted C1-C60 alkenyl, substituted C3-C60 cycloalkyl, or substituted C3-C60 cycloalkenyl, substituted C3-C60 aryl.

13. The greenhouse system of claim 10, wherein the silane is 1,3-divinyltetramethyldisiloxane, 1,3-diphenyltetramethyldisiloxane, 3-aminopropyltrimethoxysilane, 3-aminopropylmethyldiethoxysilane, i-butyltriethoxysilane, i-butyltrimethoxysilane, i-propyltriethoxysilane, i-propyltrimethoxysilane, N-beta (aminoethyl) γ-aminopropyltrimethoxysilane, N-beta (aminoethyl) γ-aminopropylmethyldimethoxysilane, n-octadecyltrimethoxysilane, N-phenyl-γ-aminopropyltrimethoxysilane, n-butyltrimethoxysilane, n-propyltriethoxysilane, n-propyltrimethoxysilane, n-hexadecyltrimethoxysilane, o-methylphenyltrimethoxysilane, p-methylphenyltrimethoxysilane, tert-butyldimethylchlorosilane, a-chloroethyltrichlorosilane, beta-(3,4-epoxycyclohexyl) ethyltrimethoxysilane, beta-(3,4-epoxycyclohexyl) ethyltrimethoxysilane, beta-chloroethyltrichlorosilane, beta-(2-aminoethyl) aminopropyltrimethoxysilane, γ-(2-aminoethyl) aminopropylmethyldimethoxysilane, γ-anilinopropyltrimethoxysilane,γ-aminopropyltriethoxysilane, γ-aminopropyltrimethoxysilane, γ-glycidoxypropyltrimethoxysilane, γ-glycidoxypropylmethyldiethoxysilane, γ-glycidoxypropylmethyldimethoxysilane, γ-chloropropyltrimethoxysilane, γ-chloropropylmethyldimethoxysilane, γ-methacryloxypropyltrimethoxysilane, γ-mercaptopropyltrimethoxysilane, aminopropyltriethoxysilane, aminopropyltrimethoxysilane, allyldimethylchlorosilane, allyltriethoxysilane, allylphenyldichlorosilane, ethyltriethoxysilane, ethyltrichlorosilane, ethyltrimethoxysilane, octadecyltriethoxysilane, octadecyltrimethoxysilane, octyltrimethoxysilane, chloromethyldimethylchlorosilane, diethylaminopropyltrimethoxysilane, diethyldiethoxysilane, diethyldimethoxysilane, dioctyl aminopropyltrimethoxysilane, diphenyldiethoxysilane, diphenyldichlorosilane, diphenyldimethoxysilane, dibutylaminopropyldimethoxysilane, dibutylaminopropyltrimethoxysilane, dibutylaminopropylmonomethoxysilane, dipropylaminopropyltrimethoxysilane, dihexyldiethoxysilane, dihexyldimethoxysilane, dimethylaminophenyltriethoxysilane, dimethylethoxysilane, dimethyldiethoxysilane, dimethyldichlorosilane, dimethyldimethoxysilane, decyltriethoxysilane, decyltrimethoxysilane, dodecyltrimethoxysilane, triethylethoxysilane, triethylchlorosilane, triethylmethoxysilane, triorganosilyl acrylate, tripropylethoxysilane, tripropylchlorosilane, tripropylmethoxysilane, trihexylethoxysilane, trihexylchlorosilane, trimethylethoxysilane, trimethylchlorosilane, trimethylsilane, trimethylsilylmercaptan, trimethylmethoxysilane, trimethoxysilyl-γ-propylphenylamine, trimethoxysilyl-γ-propylbenzylamine, naphthyltriethoxysilane, naphthyltrimethoxysilane, nonyltriethoxysilane, hydroxypropyltrimethoxysilane, vinyldimethylacetoxysilane, vinyltriacetoxysilane, vinyltriethoxysilane, vinyltrichlorosilane, vinyltris (beta-methoxyethoxy) silane, vinyltrimethoxysilane, phenyltriethoxysilane, phenyltrichlorosilane, phenyltrimethoxysilane, butyltriethoxysilane, butyltrimethoxysilane, propyltriethoxysilane, propyltrimethoxysilane, bromomethyldimethylchlorosilane, hexamethyldisiloxane, hexyltrimethoxysilane, benzyldimethylchlorosilane, pentyltrimethoxysilane, methacryloxyethyldimethyl (3-trimethoxysilylpropyl) ammonium chloride, methyltriethoxysilane, methyltrichlorosilane, methyltrimethoxysilane, methylphenyldimethoxysilane, monobutylaminopropyltrimethoxysilane, or mixtures thereof.

14. The greenhouse system of claim 10, wherein the silane is 3-methacryloxypropyltrimethoxysilane, vinyltrimethoxysilane,(3-mercaptopropyl)trimethoxysilane, 3-(methacryloyloxy)propyldimethylethoxysilane, 3-(methacryloyloxy)propenyltrimethoxysilane, and 3-(methacryloyloxy)propyltrimethoxysilane, or mixtures thereof.

15. The greenhouse system of claim 10, wherein the heating comprises bringing the surface-modifying phosphor reaction mixture to a temperature of 50° C. to 70° C. for a period of 30 minutes to 3 hours.

16. The greenhouse system of claim 10, further comprising micronizing, grinding, or combinations the isolated surface-modified phosphor material to provide isolated surface-modified phosphor material with a particle size of 1 nm to 1000 nm.

17. The greenhouse system of claim 16, wherein the particle size of the isolated surface-modified phosphor material is 6 nm to 400 nm.

18. The greenhouse system of claim 10, wherein the surface-modifying solution has a pH of 2 to 5.

19. The greenhouse system of claim 10, wherein the surface-modifying solution has a pH of 3 to 4.

20. An article comprising 0.01 wt % to 10 wt % of a surface-modified phosphor material and 99.99 wt % to 90 wt % of a matrix material, based on the total weight of the surface-modified phosphor material and the matrix material.
